(19) United States
(12) Patent Application Publication
(10) Pub. No.: US 2008/0087189 A1
(43) Pub. Date: Apr. 17, 2008

(54) SECURITY PIGMENTS AND THE PROCESS OF MAKING THEREOF

(75) Inventors: Hai Hui Lin, Mason, OH (US); Philippe Schottland, West Chester, OH (US); Russell J. Schwartz, Cincinnati, OH (US); Stephen Postle, Glen Rock, NJ (US); Caspar Lee, Clevedon (GB); Kenneth Fields, Cincinnati, OH (US); Aaron Hollman, Union, KY (US)

Correspondence Address: FROST BROWN TODD, LLC, 2200 PNC CENTER, 201 E. FIFTH STREET, CINCINNATI, OH, 45202, US

(73) Assignee: Sun Chemical Corporation, Parsippany, NJ (US)

(21) Appl. No.: 11/743,307

(22) Filed: May 2, 2007

Related U.S. Application Data
(63) Continuation-in-part of application No. 11/542,082, filed on Oct. 3, 2006.
(60) Provisional application No. 60/723,371, filed on Oct. 3, 2005.

(51) Int. Cl. C01F 17/00; C04B 14/34; C09D 11/00

(52) U.S. Cl. 106/31.9; 106/401; 423/263

(57) ABSTRACT

Disclosed are rare earth pigments, and methods for making and using these pigments, in security applications. The rare earth pigments are IR absorbers with unique spectral features and optionally exhibit color inconstancy.

### CROSS REFERENCE TO RELATED APPLICATIONS

This application is a continuation-in-part of application Ser. No. 11/542,082, filed Oct. 3, 2006, which claims the benefit of U.S. Provisional Application No. 60/723,371, filed Oct. 3, 2005, the disclosure of which is hereby incorporated by reference in its entirety.

### FIELD OF THE INVENTION

The invention relates to a family of IR pigments, and in particular, crystalline, rare earth pigments. The pigments exhibit absorption peaks in the IR which allow easy detection of a unique spectral signature. The primary intended application is a security feature of currencies and other secured documents.

### BACKGROUND OF THE INVENTION

Over the past few years, counterfeiting has become a major issue affecting companies, individuals and governments. Companies are faced with growing revenue losses due to forgery or piracy and a potential decrease in brand value. Governments are primarily concerned with tax revenue protection and Homeland Security which are both affected by document and item counterfeiting. Given the increasing technical sophistication of counterfeiters especially in recent years, traditional security features are gradually becoming irrelevant. There is an urgent need to invent new security features to stay ahead of counterfeiters. Security features can be classified into three categories, covert, semi-covert and overt. Covert applications such as IR inks and micro-tagged inks require expensive analytical (or forensic) equipments for the authentication. Semi-overt features such as micro-prints and micro-inserts can be authenticated using readily available inexpensive devices (e.g., magnifying glasses). Overt security features (or taggants) do not require the use of a specific tool or device.

Over the past decade, an abundance of covert features has been introduced on the market. However, there is a chronic shortage of novel ideas for overt and semi-overt applications and it is likely that semi-overt security features will be preferred due to ease of authentication. The present invention discloses new pigments, methods of making the pigments, and methods of tagging and authenticating for this particular application.

Spectrally selective non-visible electromagnetic radiation absorbing inks, in particular infrared (IR) absorbing inks, are widely known and used in the art. Infrared (IR) absorbing inks serve among others for the printing of machine readable markings such as text, numbers or barcodes, as well as for the printing of anti-counterfeit markings which help to authenticate articles carrying such inks. In particular, the growing field of brand-protection applications calls for covert markings, which can be applied through traditional offset or packaging printing.

EP 340898 discloses a method of authentication, wherein a first identification mark comprising a colorless material having high absorption in the near infrared is applied to an article, and this mark is subsequently overprinted with a second identification mark comprising a colorant which does not have absorption in the near infrared. This method requires the printing of two different inks on top of each other.

WO 90/1604 discloses an authenticating system for authenticating an article carrying a IR-taggant. Said IR-taggant is chosen such as to have a characteristic wavelength-selective light absorption spectrum. As an example of wavelength selective absorbing IR-taggants exhibiting narrow absorption characteristics, rare earth compounds are suggested.

Inorganic particles have been used as a marking means through incorporation into or application onto any desired article. In one application, they provide a high security potential against counterfeiting since the analysis depends on a combination of spatial as well as of chemical information, see U.S. Pat. No. 6,200,628.

The luminescent and absorption patterns of compositions may be used to authenticate articles as disclosed in U.S. Pat. No. 6,402,986; and U.S. Pat. No. 5,760,384. The use of inks containing an IR-absorbing compound (IR-taggant) may also be used for the purpose of authenticating articles as disclosed in U.S. Pat. No. 6,926,764.

Since rare earth materials are a relatively expensive class of compounds, a process to efficiently manufacture the security pigments is highly desirable, especially if the process does not create special health and safety risks. In addition, mitigation of pigment to crucible fusion is also desired from a processing perspective. Novel rare earth materials that have unique IR spectra are also highly desirable.

### BRIEF SUMMARY OF THE INVENTION

The present invention provides methods for using rare earth color inconstancy pigments, in security applications, and preferably in semi-overt and covert security applications. This is done by exploiting the mechanism of rare earth (RE) materials that have a discrete absorption band located in the visible (in particular holmium-based and neodymium-based materials) under illumination of discrete and broad spectral distribution light sources, especially tri-phosphor fluorescent light (TL84) and sunlight (D65). The color change exhibited by these color inconstancy pigments is not due to a luminescent emission. This is important as lanthanide phosphors are known for instance as up-converting phosphors. The color change observed for these rare earth-based color inconstancy pigments of the present invention is due to the light absorbed and/or reflected by the pigment and not from an excitation/luminescence emission process.

The present invention also provides synthesis (manufacturing) processes for making color inconstancy pigments, preferably the rare earth-based color inconstancy pigments that have a discrete absorption band located in the visible region of the electromagnetic spectrum, and especially those with holmium-based and neodymium-based materials.

The present invention also provides color inconstancy materials produced by the process of the present invention and compositions and articles made therewith. The present invention also provides compositions comprising RE elements including, but not limited to holmium, neodymium, ytterbium, dysprosium, and praseodymium-based color inconstancy pigments, especially those produced by the process of the present invention.

The present invention further provides methods of tagging articles with the color inconstancy pigments of the present invention comprising incorporating the taggant into a composition such as an ink, coating, paper, fiber or a polymer matrix and forming a tagged security article that exhibits extreme color inconstancy.

The present invention also provides methods of authenticating an article tagged with color inconstancy pigments including selecting a broad spectral light source and a discrete spectral light source wherein at least one emission peak of the discrete light source matches the absorption of the color inconstancy pigment.

The present invention further provides method of providing a security feature by using narrow band absorption pigments matched with specific discrete emission light sources to create an extreme color inconstancy effect.

The present invention also provides pigments/dyes that have a similar color inconstancy effect to the above color inconstancy pigments when exposed to discrete light source vs. broad light source as a result of the presence of a strong absorption band at a key wavelength of the discrete light source. Non-limiting examples include squaraine dyes/pigments that have a very narrow absorption peak that can be tuned to absorb at a key source emission wavelength.

The present invention also provides RE pigments that can also be used to produce covert security features. The covert features are associated with sharp multi-peak absorptions in the infrared range. An example pigment is the Neodymium Phosphate material of this invention which shows a multiple infrared fingerprint spectrum. Infrared fingerprints may be used for example in automated telling machine (ATM) to verify the authenticity of banknotes or cards. Note that the infrared peaks produced by the pigments of this invention are located in a range that is easily accessible for low cost light emitting diodes and photodetectors which makes them a very interesting solution. The pigments have a unique spectral fingerprint with highly intense absorption peaks in order to allow an easy detection with a unique spectral signature. The efficient manufacture of this material combines these product characteristics with maximum product yield.

### BRIEF DESCRIPTION OF THE FIGURES

FIG. 1 shows the ATR reflectance curve of Holmium Phosphate (HoPO₄) pigment. Key bands are at 419 nm, 455 nm, 468.89 to 487.04 nm, 540 nm, and the series of bands at 643 to 659 nm. The primary band (broad) is at 363 nm.

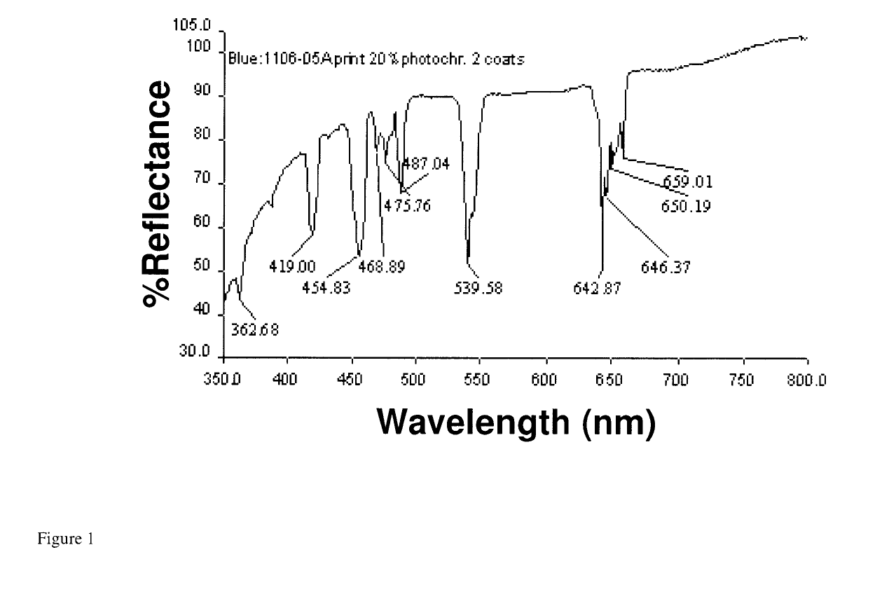

FIG. 2 shows the X-ray diffraction pattern of the synthesized HoPO₄ pigment with the key peak at 25.8 on the 2-theta scale and an absolute intensity of 1193.

FIG. 3 shows the ATR spectrum of Neodymium Phosphate (NdPO₄) pigment. Key bands are at 524.7 nm, 580.1 nm, 737.3 nm, 743.7 nm, 791.7 nm, 800.0 nm, 804.3 nm, 862.7 nm, and 871.0 nm.

FIG. 4 shows the reflectance NIR (near infrared spectrum) spectrum of dysprosium phosphate (DyPO₄). Key bands are at 914.9 nm, 1114.2 nm, 1276.5 nm and 1308.1 nm.

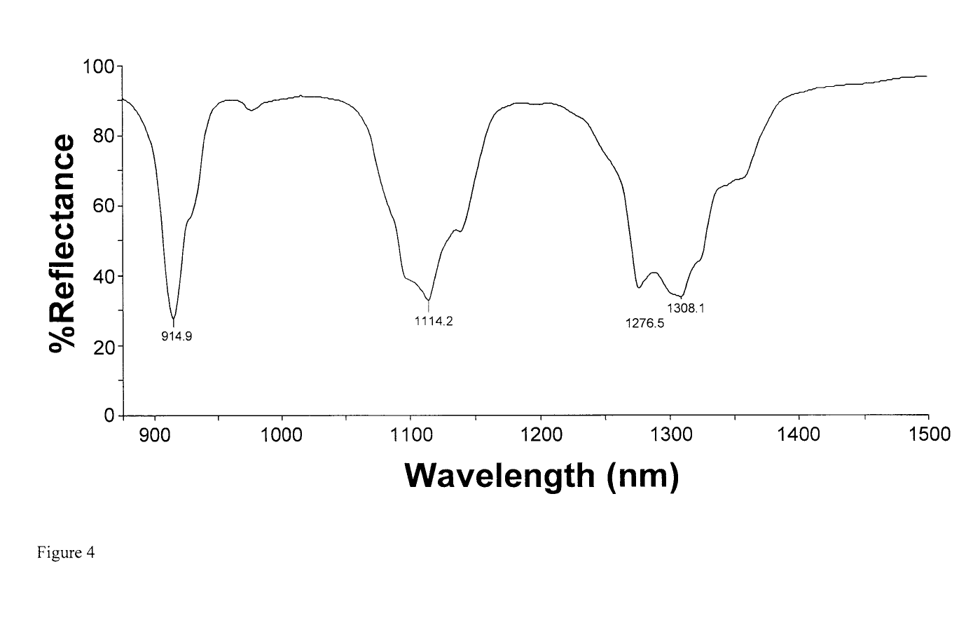

FIG. 5 shows the reflectance visible spectrum of dysprosium phosphate (DyPO₄). Key bands are at 453.8 nm, 760.9 nm, 811.9 nm, 827.6 nm.

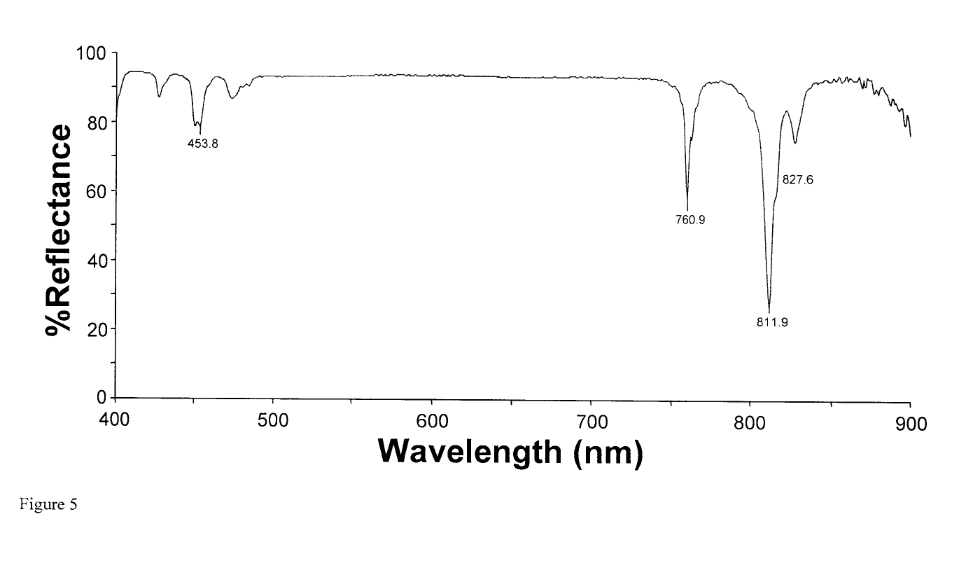

FIG. 6 shows the NIR (near infrared spectrum) absorption spectrum of ytterbium sulphide/phosphate (YbPO₄) pigments. Key bands are at 953.9 and 976.6 nm.

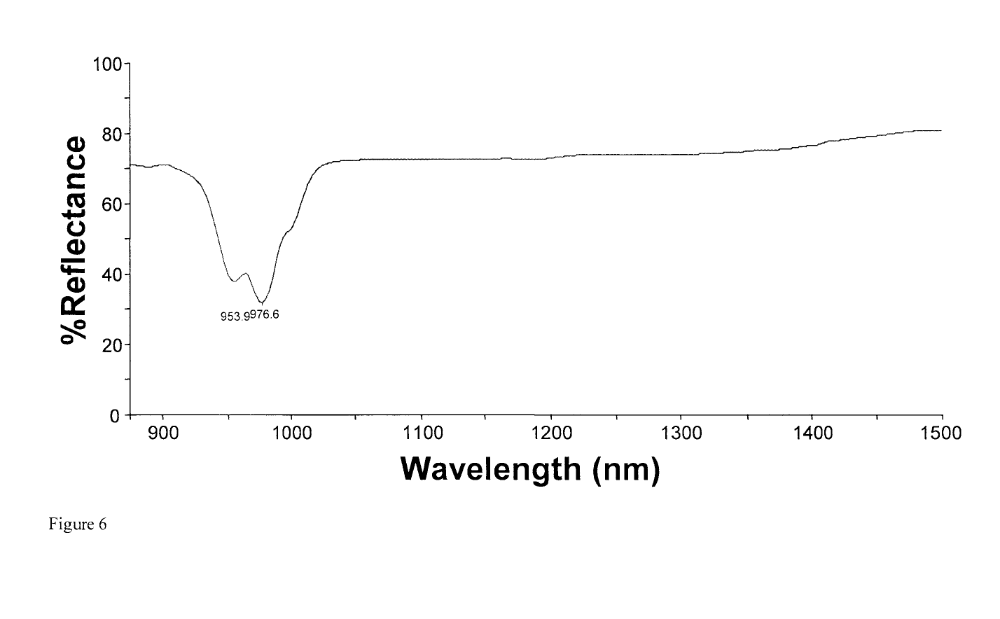

FIG. 7 shows the reflectance spectrum of example 17-12.

FIG. 8 shows the reflectance spectra of three batches of example 19.

FIG. 9 shows the spectra of the print in example 20.

FIG. 10 shows the spectra of the print in example 22.

FIG. 11 shows the XRD (X-Ray diffraction) spectra of commercially available NdPO₄.

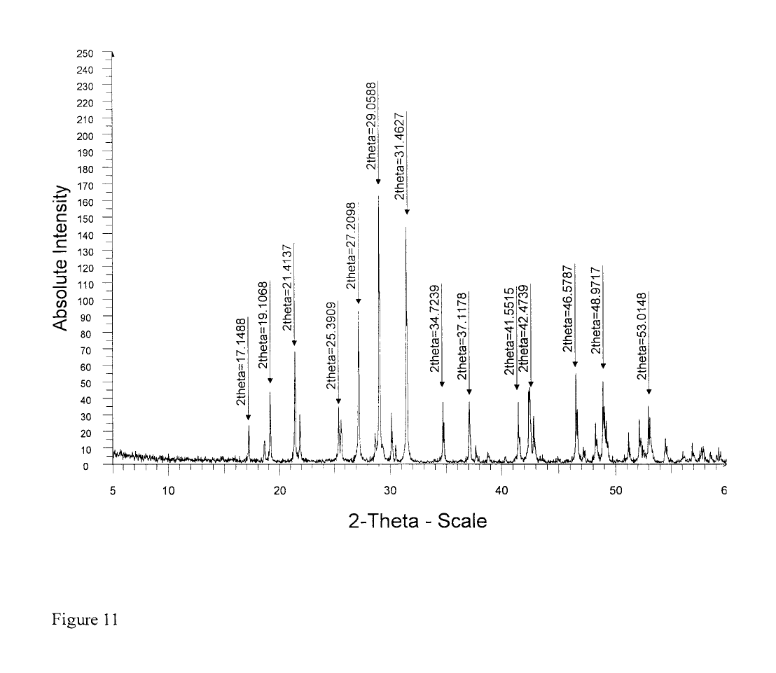

FIG. 12 shows the XRD spectra of example 17-9.

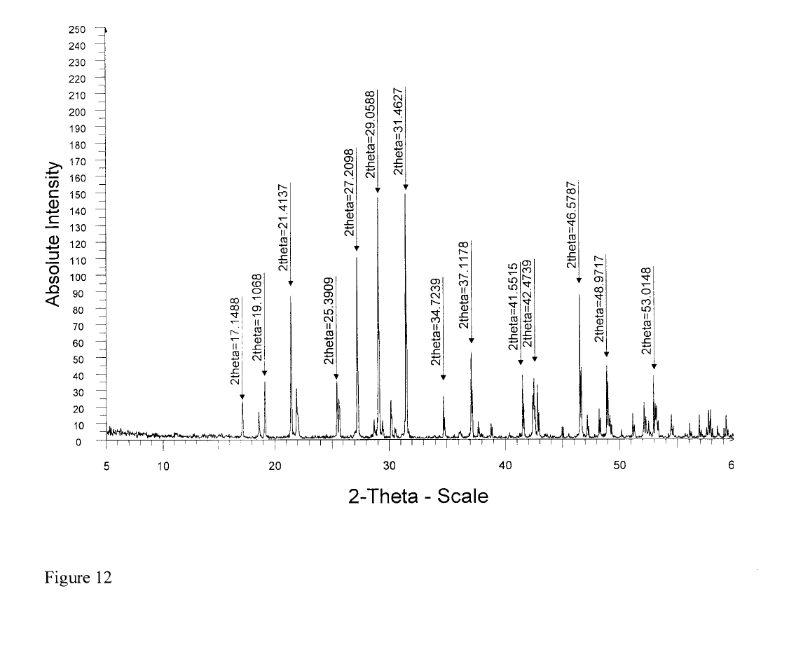

FIG. 13 shows the XRD spectra of example 17-11.

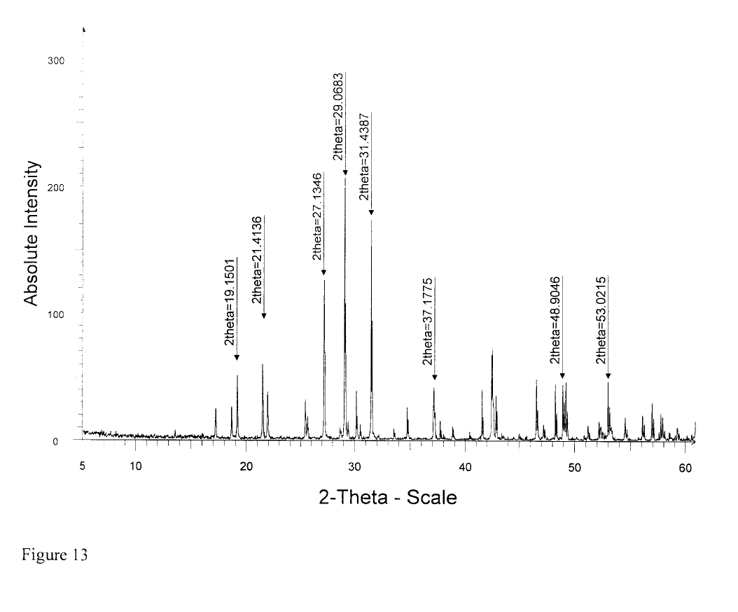

FIG. 14 shows the XRD spectra of example 17-12.

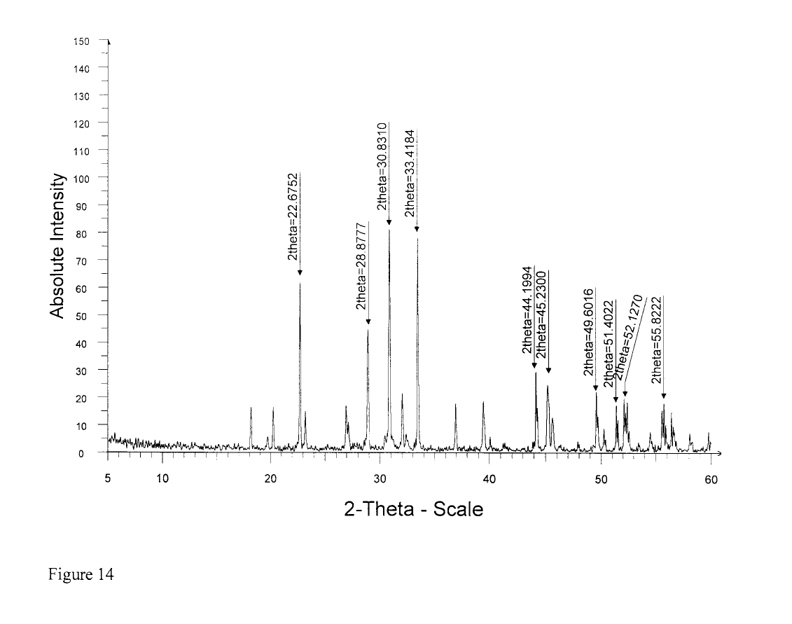

FIG. 15 shows the XRD spectra of example 19, batch 1.

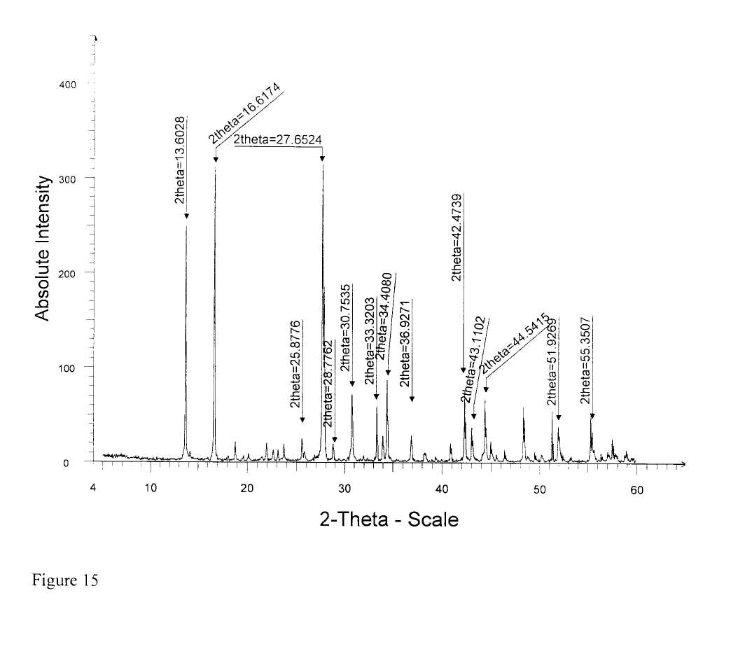

FIG. 16 shows the XRD spectra of example 19, batch 4.

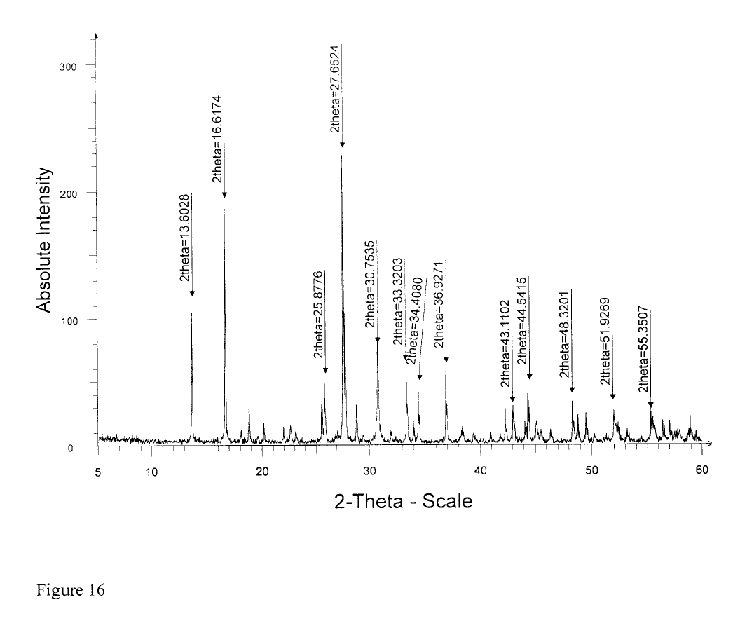

### DETAILED DESCRIPTION OF THE INVENTION

### Definitions

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

“Color inconstancy” refers to the apparent change in color of a single sample under different light sources having different wavelengths. The degree of Color inconstancy for a sample is represented by the Euclidean difference (color distance) between the corresponding color of a sample, or color coordinates calculated from the spectral curve (such as for example, remission), and the actual color of that sample measured, or computed via its color coordinates in the reference illuminant. The larger the Euclidean color distance, the greater the color inconstancy and vice-versa.

“Extreme (ultra) color inconsistency” is defined as an dramatic change in appearance of the pigment with a change in viewing conditions.

A “pigment” is a material that changes the color of light it reflects as the result of selective color absorption.

“Quantum dots” (QD), also known as nanocrystals, refers to semiconductors, which are crystals composed transition elements, lanthanides and actinides. Quantum dots comprise a unique class of semiconductor because of their size, which ranges from about 2 to about 10 nanometers (10-50 atoms) in diameter.

“Rare Earth (RE) elements” refers to the lanthanide series of elements La, Ce, Pr, Nd, Pm, Sm, Eu, Gd, Tb, Dy, Ho, Er, Tm and Yb (lanthanum, cerium, praseodymium, neodymium, promethium, samarium, europium, gadolinium, terbium, dysprosium, holmium, erbium, thulium, ytterbium). The initials ‘RE’ are used throughout the specification to refer to these rare earth elements.

The “rare earth color inconstancy pigment” refers to pigments comprising a lanthanide-based material with the appropriate counterion/ligand for the oxidation state of the given lanthanide. The lanthanides include La, Ce, Pr, Nd, Pm, Sm, Eu, Gd, Tb, Dy, Ho, Er, Tm and Yb; and the counterions/ligands include, but are not limited to phosphate, oxide, sulfide, halides (fluoride, chloride, bromide), oxyhalide, carbonate, oxalate, and hydroxycarbonate. Note that lanthanide phosphates of the general formula LaPO₄ are also referred to ‘orthophosphates.’ These terms are to be used interchangeably in this invention. Also note that ‘oxysulfide’ ligands/counterions are excluded from the scope of this invention.

The Visible Spectrum refers to wavelengths of light from about 380 nm to about 760 nm.

A family of color inconstancy pigments has been discovered. These pigments exhibit dramatic color-change when switching from one illumination source to another, particularly between a broad spectral distribution light source (e.g., outdoor light) and a discrete spectral distribution source (e.g., indoor white fluorescent light based on a tri-phosphor lamp). This unique effect is perceived by the human eye as a “photochromic” change. Rarity of the material and the ease of authentication make this family of pigments promising materials for semi-overt security features on currencies, credit cards and secure documents in general, such as identity cards, driver licenses and passports. Although the pigments are particularly suitable for use in an ink system, they could also be used in coating or plastics applications to provide security or special effect features.

The pigments of the present invention comprise rare earth (RE) materials. In another embodiment, the pigments of the present invention comprise crystalline and highly pure RE materials, specifically including holmium, neodymium, dysprosium, praseodymium, and ytterbium materials. Examples include glass encapsulated holmium chloride or fluoride, glass encapsulated holmium oxide, naked and glass encapsulated holmium phosphate, naked and glass encapsulated holmium-yttrium sulfide pigment, holmium-yttrium hydroxycarbonate pigment, and likewise for neodymium, praseodymium and yttrium and other rare earth elements. Encapsulating materials may also be various types of polymers. The holmium-based material primarily exhibits pink to yellow color transition when being switched to viewing conditions in indoor fluorescent light and outdoor sunlight, whereas neodymium-based materials exhibits blue-gray to violet color transition. The invention also covers any combination of above classes (Ho³⁺ and Nd³⁺, Pr³⁺, Yb³⁺, Y³⁺) materials (either physical blend or solid solution) for utilizing their color inconstancy characteristics.

Although color inconstancy in dyes and pigments is a known phenomenon, the materials of this invention exhibit a very strong color inconstancy effect when comparing the appearance under a broad spectral distribution light source versus a discrete spectral source (e.g., a tri-phosphor lamp). This color inconstancy effect of these materials may be attributable to both sample purity and crystallinity of the sample.

The pigments of the present invention also provide sharp multi-peak absorptions in the infrared range with highly intense absorption peaks in order to allow an easy detection with a unique spectral signature. The sharp multi-peak absorptions may be useful as security features for authenticating documents such as: currencies, credit cards and secure documents in general, such as identity cards, driver licenses and passports. Although the pigments are particularly suitable for use in an ink system, they could also be used in coating or plastics applications to provide security or special effect features

Applications

As security taggants, this family of pigments can be incorporated into or onto secured paper and/or fabric documents, substrates and packaging in forms on inks, coatings, laminates, inserts, etc. Given the ease of authentication, overt security features are the primary applications. The arts of making inks and coatings, as well the various printing processes (i.e., intaglio, flexo, screen, offset, gravure) are very well known in the literatures, so it is not repeated here [see “The Printing Ink Manual”, 5^{th} edition, R. H. Leach, ed. Taylor & Francis, Inc.]. Other less common printing processes include digital offset solutions such as the Hewlett-Packard Indigo presses which are used for instance in the production of security labels. Besides the topical applications such as printings or coatings, the pigments can be incorporated directly into substrates during the formation stage. For example, to a make secured substrate such as passport papers, the fine pigments can be introduced along with other regular paper fillers such as calcite, talc during paper making to fill the open pores of paper near the surface. If the substrate is of plastic, such as an Australian bill, the pigment can be introduced during the extrusion of substrate.

Due to its high temperature stability, the pigment can also be incorporated into a ceramic glaze, which can be fired into a non-scratchable mark. The applications include permanent marking of high-priced ceramic, glass and porcelain artworks, engine parts, or any other valued objects with metal, glass or ceramic surfaces. Its high temperature stability will also allow for many demanding plastics applications such as extruding into polycarbonate, polyester (such as polyethyleneterephthalate) and other high performing engineering plastics and fibers.

Rare earth color inconstancy pigments may be used alone or in combination with other pigments (meaning either in the same layer or in a different layer such as an overprint), dyes or additives such as those listed in “The Printing Ink Manual” by R. H. Leach, 5^{th} edition (ed. Taylor & Francis Inc., 1993). Traditional pigments or dyes (often referred to as colorants) would be used to alter the colored state of the article, print or coating under a certain light source. By doing so, one color inconstancy pigment can provide multiple security features that can be for example assigned to specific applications, markets, products or customers. Other than traditional colorants, special effect pigments may be used either in the same layer or applied in an adjacent layer (e.g., an overprint) to the color inconstancy pigment. One example would be the combination of color inconstancy pigments with security color shifting pigments such as the one commercialized by FlexProducts/JDS Uniphase (“Chromaflair” or “Secureshift” pigments), by Merck AG (“Securalic” pigments), or by Wacker (Helicones). The materials typically correspond to inorganic substrates with multiple layers having different refractive indices that will produce a light interference effect with incident light which translates into a viewing angle dependent color.

Security inks are broadly defined as inks used for security purposes, such as to prevent counterfeiting or unauthorized photocopying. Examples include water- and solvent chemical-fugitive inks, UV-sensitive inks, and magnetic inks. Accordingly, in another aspect, the product or product package may also include visible or invisible ink containing a particular photoreactive active compound for visualization (i.e., a ‘security ink’). The photoreactive material includes ultraviolet or near infrared absorbers, fluorescent compounds and phosphors (both down-converting or up-converting) or combinations thereof. The ink may be printed in one or more locations on the product or product packaging to produce an authentication mark. In another aspect, the device includes an assembly for providing a source of light to irradiate the ink containing the light-sensitive compound on the sample product or product package, an optical detector to detect certain spectral properties emitted or absorbed by the irradiated ink and a controller to determine the authenticity of the sample product or product package by comparing the emitted or absorbed properties to a standard. It is to be appreciated that the term “authentic”, or any derivative thereof, means an identification as being genuine or without adulteration or identification of point of origin or other desired information. Authentication marks are defined as follows: a] the case where the ink is printed to form very small marks (e.g. below 100 microns in size) not visible (i.e., “invisible ink”) to the naked eye but that are used to encode information for example via steganography; and b] the case where the ink is printed next to or inside a colored layer that matches its color under normal lighting conditions (e.g. broad light sources). The security mark would then be revealed when the light source is switched to a different spectral distribution (e.g. a tri-phosphor) because of the contrast created between the 2 colors (i.e., “visible ink”)

The ink may be applied to any substrate such as a package or product, by any technique capable of causing the ink to adhere to the substrate, including any technique by which conventional inks may be transferred. For example, any kind of printer can be used, such as a flexographic, gravure or offset press, an ink jet printer, digital offset printer, screen printing, or pad printing. Alternatively, the ink may be first applied to a decal or adhesive label which is in turn applied to the substrate. Such ink compositions and methods of detecting security features are described in U.S. Pat. Nos. 7,079,230; 6,786,954; 6,770,687; 6,613,137; 6,472,455; 5,983,065; 5,837,042; and 5,718,754. The entire disclosure of all applications, patents, publications, cited above and below, are herein incorporated by reference.”

Water-based printing inks for use in flexographic printing processes are known in the prior art. Printing by the flexographic process requires relatively low pressure while sufficient pressure is applied to transfer the ink from the face of the image carrier to the surface of the substrate. Examples of useful water-based flexographic printing inks are disclosed in U.S. Pat. No. 4,173,554, U.S. Pat. No. 5,725,646 and The Printing Ink Manual, edited by R. H. Leach and R. J. Pierce, pages 571-576, 5th edition, (Blueprint, 1993).

Water-based inks for gravure printing are also well known. In the gravure process, the printing image is engraved into a cylinder in the form of cells which become filled with ink. Printing is achieved by passing the substrate between the gravure cylinder and impression roller under pressure. Examples of useful water-based gravure printing inks are disclosed in U.S. Pat. Nos. 4,954,556 and 5,098,478.

Conventional offset lithographic printing processes, the plate is damped before it is inked with an oil-based ink. Typically, the damping process utilizes a fountain solution such as those described in U.S. Pat. Nos. 3,877,372, 4,278,467 and 4,854,969.

When used in an ink or coating, the color inconstancy pigment are generally incorporated at a loading varying from 20 to 80 weight percent, with 30 to 70 wt % being more desirable and 40 to 60 wt % preferred. As known by those skilled in the art, adequate print thickness needs to be achieved for the security feature to be easily detectable by the naked eye. Of course, if the detection of color inconstancy is done via a machine read then lower loadings of pigment and/or thinner layers may be used.

Synthesis of RE Color Inconstancy Pigments

Several classes of RE color inconstancy pigments are provided in this application. These pigments include:
1. Naked RE sulfide, and its glass encapsulated counterparts.
2. Naked RE-yttrium sulfide, and their glass encapsulated counterparts.
3. Glass encapsulated RE oxide nanocomposite.
4. Glass encapsulated RE fluoride nanocomposite.
5. Glass encapsulated RE chloride nanocomposite.
6. RE-yttrium hydroxycarbonate.
7. Holmium—yttria ceramic.
8. Neodymium—yttria ceramic.
9. Glass encapsulated RE orthophosphates, including holmium orthophosphate (HoPO₄) and neodymium orthophosphate (NdPO₄) (also referred to as ‘holmium phosphate’ and ‘neodymium phosphate’).
10. Naked RE orthophosphates, including holmium phosphate (HoPO₄) and neodymium orthophosphate (NdPO₄) (also referred to as ‘holmium phosphate’ and ‘neodymium phosphate’).

One embodiment of the invention is a crystalline compound comprising neodymium and phosphate, characterized by an X-ray powder diffraction pattern having peaks at 19.1±0.2, 21.4±0.2, 27.1±0.3, 29.1±0.3, 31.5±0.3, 37.2±0.4, 42.5±0.4, 46.0±0.5, 48.9±0.5, 53.0±0.5, degrees two-theta (Siemens D5005 X-ray Diffractometer), wherein the neodymium to phosphate mole ratio is not 1. The neodymium to phosphate mole ratio may be greater than about 1. The compound may be useful as a color inconstancy pigment. An example of a color inconstancy pigment is one where its color changes from blue-gray to violet when changing the spectral distribution of the light emitted by the illumination source.

Another embodiment of the invention is a crystalline compound comprising NdPO₄, characterized by an X-ray powder diffraction pattern having peaks at 30.8±0.3, 33.3±0.3, 44.5±0.5, 51.9±0.6, 55.4±0.6, degrees two-theta (Siemens D5005 X-ray Diffractometer). The compound may be useful as a color inconstancy pigment. An example of a color inconstancy pigment is one where its color changes from blue-gray to violet when changing the spectral distribution of the light emitted by the illumination source. The crystalline compound may further comprise an X-ray diffraction pattern comprising peaks at 13.6±0.2, 16.6±0.2, 27.7±0.3, 34.4±0.3, 36.9±0.4, 43.1±0.4, 48.3±0.5, degrees two-theta.

In one embodiment the mole ratio of rare earth element to phosphate in the compound is not 1. In one embodiment the mole ratio may be less than about 1. The mole ratio may be less than about 0.7. The mole ratio may be greater than about 0.2. The mole ratio may be greater than about 0.35. In another embodiment the mole ratio of rare earth element to phosphate in the compound may be greater than about 1. The mole ratio may be greater than about 1.1. The mole ratio may be greater than about 1.3. In comparison, the rare earth element to phosphate mole ratio of NdPO₄, NdP₅O₁₄, and NdP₃O₉, are 1, 0.2 and 0.33 respectively.

Another embodiment of this invention is the process for preparing a pigment having a rare earth element, comprising: a) preparing a rare earth element based solution; b) combining the rare earth element based solution with one or more phosphate compounds to form a rare earth phosphate pigment; wherein at least one phosphate compound is a polyphosphate; and c) isolating the pigment from the solution. Optionally, the pigment may be heat-treated. The heat-treatment step may include a calcination step. The pigment may be heat-treated at or above 700° C. The pigment may comprise one or more rare earth elements.

Polyphosphates are inorganic polymeric orthophosphate units connected by phosphoanhydride bonds. Examples of polyphosphates are pyrophosphate salts (containing 2 phosphorous atoms), triphosphate salts (containing 3 phosphorous atoms), and hexametaphosphate salts. Hexametaphosphates are a mixture of highly polymeric phosphates, of which the hexamer of the same name is one of them. Illustrative examples include: M⁺ₙ(PO₃)ₙ, such as alkali metaphosphate, such as lithium metaphosphate, sodium hexametaphosphate, and potassium metaphosphate; and ammonium hexametaphosphate; M²⁺(PO₃)₂, such as Ba(PO₃)₂, and calcium hexametaphosphate; and M³⁺(PO₃)₃, such as Al(PO₃)₃; wherein M⁺ is a monovalent cation, M²⁺ is a divalent cation, and M³⁺ is a trivalent cation.

Another embodiment of this invention is a crystalline compound comprising a rare earth element, prepared by the process comprising: a) preparing a rare earth element based solution; b) combining the rare earth element based solution with one or more phosphate compounds to form a rare earth phosphate pigment; c) isolating the pigment from the solution, wherein the rare earth element to phosphate mole ratio is not 1. Optionally, the pigment may be heat-treated. The heat-treatment step may include a calcination step. The pigment may be heat-treated at or above 700° C. The crystalline compound may comprise one or more rare earth elements. The crystalline compound may comprise one or more pigments.

In the IR spectra, a band, as measured in a FT-IR spectrometer, near 1273 cm⁻¹ is indicative of polyphosphate. The pigment may have an IR band near 1273 cm⁻¹ which would indicate that the pigment comprises a polyphosphate.

A rare earth element based solution is a solution comprising a rare earth element cation, and an anion. The solution may be formed by dissolving, at least partially, a rare earth element salt in a liquid. An example salt is Nd(NO₃)₃ which may be in the hydrated form, Nd(NO₃)₃.6H₂O. The cation of the salt may be any of the rare earth elements; examples are: cerium, dysporium, erbium, europium, holmium, lanthanum, neodymium, praseodymium, samarium, terbium, and yttrium. The anion may be any anion that will form a salt with a rare earth element such that the salt is at least slightly soluble.

As employed in the specification, examples and appended claims, a phosphate compound comprises a phosphate; it may be an acid phosphate, a phosphate salt, or a polyphosphate. An example of an acid phosphate is phosphoric acid, which includes polyphosphoric acids. Phosphate salts comprise a cation such as, but not limited to: hydrogen, lithium, sodium, potassium, rubidium, aluminum, barium, or cesium. Examples of phosphate salts are sodium dihydrogen phosphate, disodium hydrogen phosphate, trisodium phosphate, diammonium hydrogenphosphate, sodium hexametaphosphate (SHMP), Ba(PO₃)₂, and Al(PO₃)₃.

In one embodiment of the process for preparing a pigment comprising a rare earth element, the one or more phosphate compounds consists of substantially polyphosphates. In this embodiment the term ‘substantially’ means that the molar amount of phosphorus in the polyphosphate is greater than the molar amount of phosphorus in any other phosphate containing compound. In another embodiment of the process for preparing a pigment comprising a rare earth element, the one or more phosphate compounds is only sodium hexametaphosphate.

In one embodiment of the process for preparing a pigment comprising a rare earth element, before the isolation of the pigment from solution, the solution has a pH of about 5.3 or less, or the pH is adjusted to about 5.3 or less by the addition of an acid. Examples of an acid are mineral acids, such as hydrochloric acid, nitric acid, polyphorphoric acid, and sulphuric acid. The pH of the rare earth phosphate pigment solution may be lower or adjusted lower than 5.3, it may be lower or adjusted lower than 3.1, 1.4, or 1.

The mixture of the rare earth element based solution and a solution of a phosphate compound is the rare earth phosphate reaction solution. The rare earth phosphate reaction solution may comprise additional one or more additional solvents. In one embodiment of the process for preparing a pigment comprising a rare earth element, the mass of the rare earth element is greater than about 3 w % of the total mass of the rare earth phosphate reaction solution. When the concentration of the rare earth element is high in the slurry, the yield of the pigment is typically better. In addition, a higher concentration of the rare earth element allows the manufacture of the pigment to be more efficient by requiring a smaller reaction vessel, less solvent, and shorter reaction times.

In one embodiment the rare earth phosphate reaction solution is mixed at a temperature less than 150° C. The temperature may be less than 100° C., 75° C., or 55° C.

In one embodiment of the process for preparing a pigment comprising a rare earth element, the pigment is re-slurried in a water bath. The pigment may be re-slurried using an ultrasonic process. After the pigment is re-slurried it may be isolated and dried to produce the pigment. Sonication of the pigment helps to remove it, from the crucible used to hold the material during the optional heat-treatment. Elimination of the need for sonication is desirable because it may be difficult to perform on a large scale. When the pH of a rare earth phosphate pigment solution is adjusted to below about 3.1 or about 1, sonication is typically not necessary to remove the pigment from the crucible. As an alternative to adjusting the pH, a crucible with a less porous surface, such as a zirconia-lined alumina crucible, is less likely to require sonication.

In one embodiment the pigment is milled to a mean particle size of about 20 μm. The pigment may be milled to a mean particle size of about 10 μm. The milling process may be one or more steps. Examples of milling processes are hammer milling, jet milling, dry ball milling, and circulating wet media milling.

In one embodiment the mole ratio of rare earth element to phosphate in the compound is not 1. In one embodiment the mole ratio may be less than 1. The mole ratio may be less than 0.7. The mole ratio may be greater than 0.2. The mole ratio may be greater than 0.35. In another embodiment the mole ratio of rare earth element to phosphate in the compound may be greater than 1. The mole ratio may be greater than 1.1. The mole ratio may be greater than about 1.3. In comparison, the rare earth element to phosphate mole ratio of NdPO₄, NdP₅O₁₄, and NdP₃O₉, are 1, 0.2 and 0.33 respectively.

Examples of rare earth elements are praseodymium, neodymium, holmium, ytterbium, samarium, erbium, and dysprosium. In one embodiment the rare earth element is neodymium. In one embodiment the neodymium phosphate has a neodymium phosphate ratio of less than about 1.

In one embodiment, the rare earth element pigment has an X-ray powder diffraction pattern comprising peaks at 30.8±0.3, 33.3±0.3, 44.5±0.5, 51.9±0.6, 55.4±0.6, degrees two-theta. The rare earth element pigment may additionally comprise X-ray powder diffraction pattern peaks at 13.6±0.2, 16.6±0.2, 27.7±0.3, 34.4±0.3, 36.9±0.4, 43.1±0.4, 48.3±0.5, degrees two-theta.

In another embodiment, the neodymium pigment has an X-ray powder diffraction pattern comprising peaks at 30.8±0.3, 33.3±0.3, 44.5±0.5, 51.9±0.6, 55.4±0.6, degrees two-theta.

In one embodiment of the invention, the pigment comprising a rare earth element, may be encapsulated or partly encapsulated. The pigment may be encapsulated or partly encapsulated in glass, such as silica or borosilicate. As an alternative the pigment may be encapsulated or partly encapsulated in a polymer.

One embodiment of the invention is a printing ink comprising a pigment comprising a rare earth element and a phosphate, wherein the printing ink further comprises a binding agent and, optionally, other additives and solvents, so as to produce an ink with a suitable rheology to be printed by at least one of the printing techniques selected from screen, intaglio, gravure, flexo, offset, inkjet, thermal transfer, xerography and letterpress. The pigment comprising a rare earth element may be made by the processes described within this specification. The rare earth element may be neodymium.

Another embodiment of the invention is a coating or adhesive formulation comprising a pigment comprising a rare earth element and a phosphate, wherein the formulation further comprises a binding agent and, optionally, other additives and solvents, so as to produce or coating or adhesive formulation with a suitable rheology to be applied by at least one of the coating techniques selected from the group consisting of flood coating, spray coating, powder coating, hot melt, lamination, roll coating, and reverse roll coating. The pigment comprising a rare earth element may be made by the processes described within this specification. The rare earth element may be neodymium.

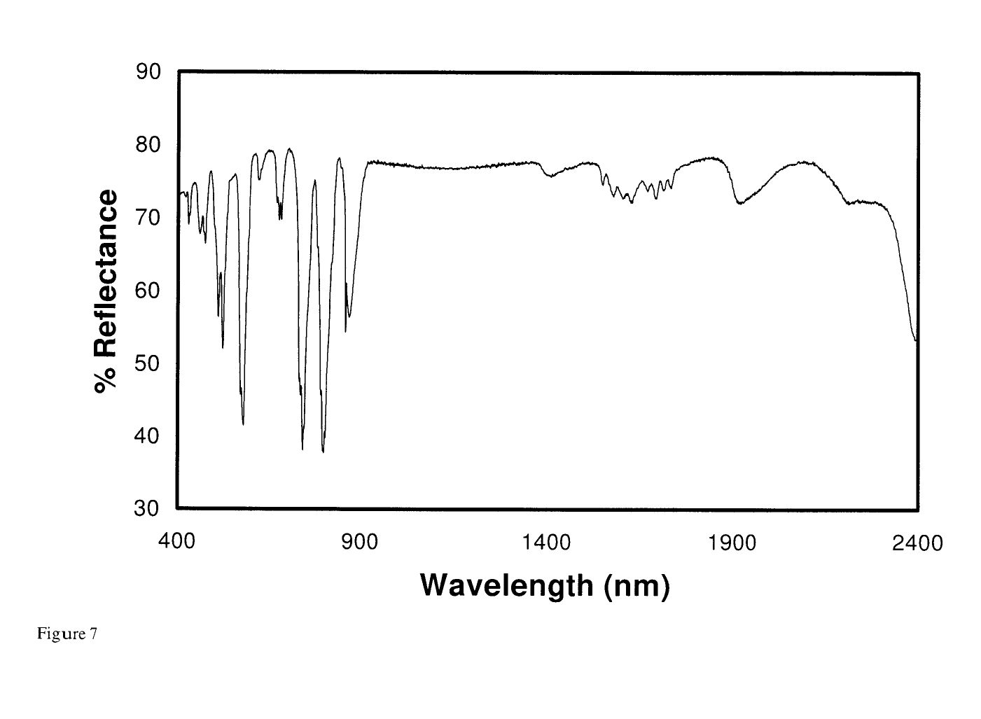

The spectrum of the rare earth element pigment would allow the ink, coating, or adhesive to be used as a security taggant. An example of a typical reflectance spectrum (corresponding to Example 17-12) is shown in FIG. 7. This figure illustrates the highly intense peaks located in the visible, NIR and far IR regions. In this example, primary absorption peaks for the visible and NIR regimes are located at 512, 524, 583, 743, 800 and 872 nm with minor peaks in the infrared region at 1424 and 1932 nm. The security taggant formed by the ink, coating, or adhesive is used to authenticate an article by the spectral characteristics of the security taggant on the document.

The security taggant is detectable by a device comprising one or more of visible, near infrared, or infrared light sources to interrogate the security taggant and one or more detectors capable of sensing the portion of the light emitted by the light source that is reflected from the security taggant. Detection of the security taggant may be for purpose of authenticating a document, or article that has been printed with an ink comprising the rare earth element pigment. The security taggant may be detectable by a visible, near infrared, or infrared light source. The light source may be one or more electroluminescent source, such as a solid state inorganic LED, organic LED, and polymer LED; lasers; or laser diodes. The detection of the security taggant may be performed in a device equipped to identify banknotes or to distribute banknotes (such as an automated teller machine or ATM). The detection of the security taggant may be performed in a device equipped to sort banknotes by denomination.

The detector may be selected from the group consisting of a photodiode, a photovoltaic cell, a metal-semiconductor-metal photodetector, a photomultiplier, a phototransistor, a photoresistor, a light to frequency converter, and a phototube; wherein the detector is optionally fitted with an optical filter

Another embodiment of the invention is a composition comprising a polymer and a pigment wherein the pigment comprises a rare earth element and a phosphate, wherein the rare earth element to phosphate mole ratio is not 1. The rare earth element to phosphate mole ratio may be less than about 1, or less than about 0.7. The pigment comprising a rare earth element may be made by the processes described within this specification. The rare earth element may be neodymium.

Another embodiment of the invention is an article comprising a pigment, wherein the pigment comprises a rare earth element and a phosphate. An article is anything that may need to be authenticated. Examples of articles are, but not limited to: items for sale that are authenticated, identification card, identification paper, documents, currency, credit cards, securities, certificate, and tax stamp.

The pigment may have a mole ratio of rare earth element to phosphate, that is not 1. The rare earth element in the pigment may comprise any rare earth element, and may comprise a mixture of rare earth elements. The rare earth element in the pigment may be neodymium.

An ink may comprise the pigment, and the ink may be printed onto the article. Alternatively, the pigment may be incorporated into the article. For example, the article may comprise plastic, and the pigment is incorporated into the plastic before, after, or during the time of manufacture of the article.

### EXAMPLES

The compositions and procedures are given below as examples.

### Example 1

### Holmium Phosphate Pigment

The synthesis pathway consists of three basic steps:
1. Formation of polyphosphate stabilized RE precursor slurry by reverse-strike process (i.e., adding to precipitant solution).
2. Formation of RE sulfide pigment by regular-strike process (i.e., adding precipitant to the solution).

3. Aggregation and Fusing of pigment via a series of purifications and thermal treatments.

Precursor Formulation Recipe for Holmium-based Pigment

| Chemical Name | CAS# | Purity | MW | Mole |
|---|---|---|---|---|
| Ho(NO₃)₃•5.4H₂O | 10168-82-8 | 99.9% | 448 | 0.06 |
| NaPO₃ | 68915-31-1 | Prac Gd | 102 | 0.24 |
| Na₂S•9H₂O | 1313-84-4 | 99.9% | 240 | 0.099 |

A 0.6M holmium solution is pumped slowly into a solution of a phosphate compound to form a 0.15M rare earth—0.6M phosphate slurry. Sodium sulfide (0.5M) is then slowly pumped into the RE-phosphate slurry under agitation over a period of 2 hours. The solution is then aged for 48 hours without agitation until it becomes a light gray opaque paste. This aging is an optional step as there are also alternative methods of drying the sample. The pigment settles by centrifugation is washed with water to remove excess sodium sulfide and other salts. The pigment is reslurried and recentrifuged until the wash water conductivity is below 2 S/m. A final wash with ethanol produces a pellet of translucent pink gel. Drying the pellet in a vacuum oven (80° C., 25″ head) shrinks the pellet to a translucent glassy mass. The pigment is then calcined in a porcelain crucible at 1100° C. for at least 2 hours, where the mass becomes denser and develops a deeper color. The product is released from the crucible by sonication in a water bath. The resulting water slurry is collected and washed in ethanol before drying at 60° C. to produce a dry pigment. Optional dry mechanical milling may be performed at this point.

This substance produces narrow and intense absorption bands at 419 nm, 455 nm, 469 to 487 nm, 540 nm and a series of bands at 643 nm to 659 nm. The primary (and somewhat broad) absorption band is at approximately 363 nm. The color of the material is pink under tri-phosphors fluorescent light and changes to a pale yellow under incandescent light.

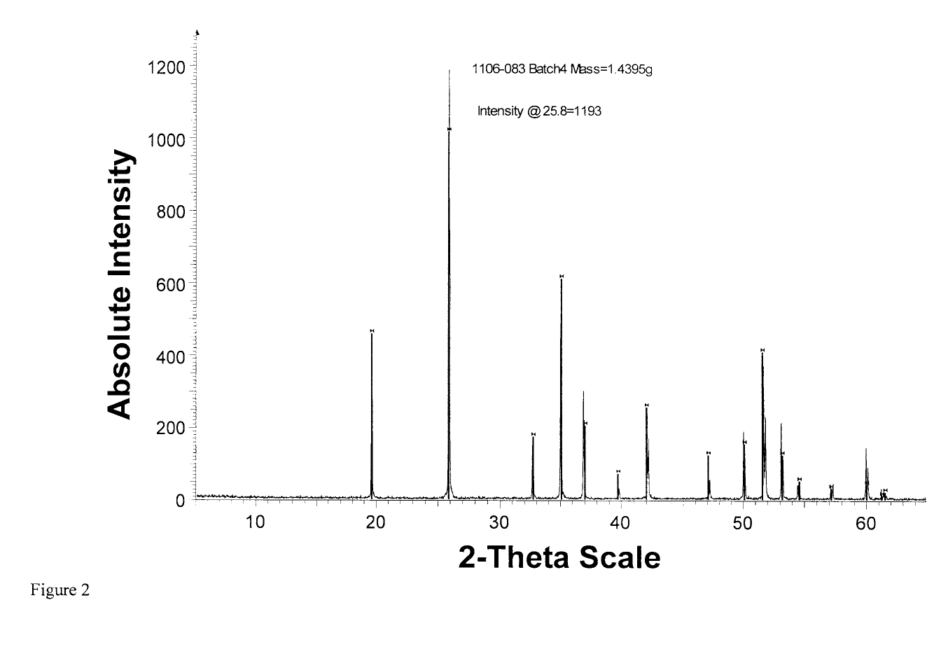

The X-Ray diffraction pattern of the synthesized pigment taken with a Siemens 505 X-Ray diffractometer indicates that the material is essentially composed of Holmium phosphate (HoPO₄), FIG. 2. Purity data from sample:

| Sample | Holmium (%) | Sulfur (%) | Sodium (%) | Phosphorus (%) |
|---|---|---|---|---|
| Prepared | 62.1 | 0.11 | 1.1 | 13.8 |
| HoPO₄ | | | | |
| HoPO₄* | 63.4 | 0 | 0 | 11.9 |

*Theoretical values for pure Holmium Phosphate

### Example 2

### Encapsulated Holmium Phosphate Pigment

Encapsulation provides a barrier to holmium phosphate-sulfide pigment. It provides the benefits of reduced moisture sensitivity, reduced pH sensitivity and universal compatibility with all solvent systems, which are essential for the demanding applications such as currency printing. Given the abrasive nature of naked holmium phosphate-sulfide pigment, there is potentially an added benefit of less wear and tear to the printing plate due to the soft glass capsule. The synthesis process is identical to example 1 until the ethanol wetted pellet is recovered from the centrifuge. This wet “presscake” with a typical dry content of 10%-13% wt is the starting material for encapsulation. The encapsulation glass can be pure silica or borosilicate. The encapsulation process is a heterogeneous sol-gel process with TEOS (tetraethyl orthosilicate) as glass precursor, or TEOS+TMB (trimethylborate) as in the case of borosilicate capsule. The example given below is a borosilicate encapsulation process, with a borate-silicate molar composition of 78/22, for its excellent glass transparency.

| Name | MW | Mass (g) | | % Mass | Mole |
|---|---|---|---|---|---|
| TEOS | 208 | 5 | | 35.2% | 0.024 |
| (tetraethyl borosilicate) | | | | | |
| TMB (trimethylborate) | 104 | 0.7 | | 4.9% | 0.0068 |
| Ethanol | 46 | 5.5 | | 38.7% | 0.12 |
| CH₃COOH | 60 | 0.144 | | 1% | 0.0024 |
| Water | 18 | 2.16 | | 15.2% | 0.12 |
| DMF (dimethyl formamide) | 73 | 0.7 | | 4.9% | 0.0096 |
| | | 14.2 | g | 100% | |

TEOS/AAc = 1:0.1
TEOS/EtOH/Water/DMF = 1:5:5:0.4
TEOS/TMB = 78/22

Procedure for Making Glass Encapsulated Holmium Phosphate Pigment:
1. Prepare borosilicate glass precursor solution: The solution is prepared under agitation following the addition order of water→DMF→CH₃COOH→Ethanol→TEOS→TMB.
2. Mixing precursor solution with Ethanol wetted “Presscake”: Homogeneous slurry (paste) of presscake and precursor solution is prepared by blending at a pre-determined ratio to give a mixture that will be about 10 part presscake+2 part precursor. The borosilicate to Ho pigment weight ratio is 1:5 to 1:3
3. Gelation and Drying: The paste is then placed into a flat tray and dried in oven between 60° C.-80° C. for 4-7 days forming a monolithic glassy mass.
4. Calcination: The glassy mass is calcined at 1100° C. for a minimum of 2 hours. The final material is of dense and hard granule form.
5. Milling (optional): The material can be prepared into a fine pigment form by conventional milling processes such as dry ball milling or circulating wet media milling.

### Example 3

### Holmium-Yttrium Phosphate/Sulfide Pigment

This synthesis procedure is similar to example 1. The only difference is that part of holmium nitrate salt is replaced with lower cost yttrium nitrate salt. Yttrium compounds are known for their transparency. The rationale for doping holmium into a transparent matrix is to boost absorption efficiency on per mole of holmium ion base.

Formulation Recipe for Holmium-Yttrium phosphate based pigments

| | | | | | Intended |
|---|---|---|---|---|---|
| Chemical Name | CAS# | Purity | MW | Mole | Mass (g) |
| Y(NO₃)₃•6H₂O | 13494-98-9 | 99.9% | 383 | 0.048 | 18.4 |
| Ho(NO₃)₃•6H₂O | 10168-82-8 | 99.9% | 459 | 0.012 | 5.5 |
| NaPO₃* | 68915-31-1 | Prac Gd | 102 | 0.24 | 24.5 |
| Na₂S•9H₂O | 1313-84-4 | 99.9% | 240 | 0.099 | 23.8 |

The material exhibited similar absorption characteristics as example 1 and 2.

### Example 4

### Glass Encapsulated Holmium Oxide Nanocomposite

The rationale for glass encapsulation is to provide barrier function to holmium oxide. It will provide the benefits of reduced moisture sensitivity, reduced pH sensitivity and universal compatibility with all solvent systems, which are essential for demanding applications such as currency printing. Holmium oxide nanophases are formed in situ inside the glass matrix. The glass precursor can be TEOS, or a combination of TEOS and TMB. The preferred holmium precursor is nitrate due to its high solubility in water/ethanol mixture. Less soluble RE precursors like acetate, oxalate or acetoacetonate can also be used if doping level is low. A typical compositional recipe is given below as an example.

Precursor Formulation for 40[½ Ho₂O₃]-60SiO₂ Pigment

| | | | | | % mole | |
|---|---|---|---|---|---|---|
| Name | MW | Mass (g) | | % Mass | (end) | Mole |
| TEOS | 208 | 12.48 | | 19.0% | 60% | 0.06 |
| Ho(NO₃)₃•5H₂O | 441 | 17.64 | | 26.8% | 40% | 0.04 |
| CH₃COOH (AAc) | 60 | 1.08 | | 1.6% | | 0.018 |
| Ethanol | 46 | 22.1 | | 33.6% | | 0.48 |
| H₂O | 18 | 10.8 | | 16.4% | | 0.6 |
| DMF | 73 | 1.75 | | 2.66% | | 0.024 |
| (dimethylformamide) | | | | | | |
| Total | | 65.85 | g | 100% | | 0.1 |

TEOS/Ethanol/water/AAc = 1:8:10:0.3 for overall composition
DMF/TEOS = 0.4, AAc/RE = 0.45:1
MW of SiO₂ = 60, MW of Ho₂O₃ = 378
Expected Dry Gel Mass = Ho(NO₃)₃ + SiO2 = 14.04 + 4.2 = 18.24 g
Expected Final Glass-ceramic Mass = 4.2 g SiO₂ + 5.67 g Ho₂O₃ = 9.87 g

Operational Procedure for Making Glass Encapsulated Ho₂O₃

The operating procedure is as follows:
1. Prepare Glass Precursor: Mix ethanol, DMF, water, acetic acid and TEOS together following the recipe given above. Stir the solution for half hour to complete the hydrolysis. The final solution should be clear, and of one phase (i.e., no water/TEOS phase separation).
2. Prepare Dopant Solution: Dissolve holmium nitrate salt in water/ethanol mixture by agitation
3. Mixing: Pump glass precursor solution into dopant solution slowly under agitation, and let stir for another hour.
4. Gelation and Drying: Pump final precursor solution into drying trays with perforated lids (i.e., a controlled evaporating vessel). The aliquot height should be less than 0.5 cm to minimize thermal stress during drying. A typical gelation and drying is holding at 60° C. for 5 days, and then 80° C. for 5 days, followed by 2 days at 140° C. At the end of this step, the solution will turn into a dense and transparent glass.
5. Calcination and Densification: A typical calcination is 1° C./min to 950° C. and then ramp to 1100° C. in one hour and hold for 2 hours. The final material is of dense and soft granule form.
6. Milling: The material can be prepared into pigment form by conventional milling processes such as dry ball milling or circulating wet media milling. For dry ball milling, 3/16″ to ⅛″ Burundum porcelain media or yttrium fortified zirconia media are recommended. For wet milling, 0.3 mm-0.5 mm yttrium fortified zirconia media is recommended.

### Example 5

### Glass Encapsulated Holmium Fluoride Nanocomposite Pigment

The rationale for glass encapsulation is to provide barrier function to holmium fluoride. It will provide the benefits of reduced moisture sensitivity, reduced pH sensitivity and universal compatibility with all solvent systems, which are essential for demanding applications such as currency printing. Holmium fluoride nanophases are formed in situ inside the glass matrix. The glass precursor can be TEOS, or a combination of TEOS and TMB. One example of such formulation is given below. The operating procedure is similar to example 4, so it is not repeated here. The only difference is that TFA is used in place of acetic acid and the amount is substantially larger.

Precursor Formulation for Pigment

| Name | MW | Mass (g) | | % Mass | Mole |
|---|---|---|---|---|---|
| TEOS | 208 | 22.48 | | 20.6% | 0.108 |
| Ho(CH₃COO₃)₃•H₂O (SA) | 360 | 14.4 | | 13.2% | 0.04 |
| CF₃COOH (TFA) | 114 | 12 | | 11.0% | 0.105 |
| Ethanol | 46 | 27.6 | | 25.3% | 0.6 |
| H₂O | 18 | 31 | | 28.4% | 1.72 |
| DMF | 73 | 1.75 | | 1.6% | 0.024 |
| Total | | 109.2 | g | 100% | 0.148 |

Theoretical Final Mass: HoF₃ = 8.88 g, SiO₂ = 6.48 g → Total = 15.36 g
TFA/RE = 2.6
Dissolution Liquid Composition: 28/72 mixture of TFA/H₂O by weight

### Example 6

### Glass Encapsulated Holmium Chloride Nanocomposite

The entire synthesis procedure is similar to example 4, except that trichloroacetic acid is used in place of TFA, and the calcination temperature is substantially lower. The maximum calcination temperature is 500° C. At above this temperature, HoCl₃ will gradually turn into Ho₂O₃ due to the loss of chloride as HCl gas. Due to the low annealing temperature (i.e., 500° C. vs. 1100° C.), this pigment is more porous than pigments of example 1 to 5. A typical recipe is given below.

Precursor Formulation for 30HoCl₃-70SiO₂ Pigment

| | | | | | % mole | |
|---|---|---|---|---|---|---|
| Name | MW | Mass (g) | | % Mass | (end) | Mole |
| TEOS | 208 | 14.56 | | 18.9% | 70% | 0.07 |
| Ho(CH₃COO₃)₃•H₂O | 360 | 10.8 | | 14.0% | 30% | 0.03 |
| CCl₃COOH (TCA) | 163 | 14.67 | | 19.0% | | 0.09 |
| Ethanol | 46 | 16.1 | | 20.9% | | 0.35 |
| | | (8 + 8.1) | | | | |
| H₂O | 18 | 18.9 | | 24.5% | | 1.05 |
| DMF | 73 | 2.04 | | 2.7% | | 0.028 |
| Total | | 77.07 | g | 100% | | 0.1 |

MW of HoCl₃ = 271, MW of SiO₂ = 60, MW of Ho(TCA)₃ = 651
Expected Dry Gel Mass = Ho(TCA)₃ + SiO2 = 19.53 + 4.2 = 23.73
Expected Final Glass-ceramic Mass = 4.2 g SiO₂ + 8.13HoCl₃ = 12.33 g

### Example 7

### Holmium-Yttrium Hydroxycarbonate Pigment

The synthesis procedure is almost identical to example 3. One difference is that the precipitant is Na₂CO₃ rather than Na₂S. As a result, a hydroxycarbonate pigment is formed rather than a sulfide pigment. The maximum calcination temperature for this pigment is 300° C. Above that temperature, hydroxycarbonate is dehydrated and turned into oxide. A typical formulation recipe is given below.

Formulation Recipe for Pigment

| Chemical Name | CAS# | Purity | MW | Mole |
|---|---|---|---|---|
| Y(NO₃)₃•6H₂O | 13494-98-9 | 99.9% | 383 | 0.0462 |
| Ho(NO₃)₃•5.4H₂O | 10168-82-8 | 99.9% | 448 | 0.0138 |
| NaPO₃* | 68915-31-1 | Prac Gd | 102 | 0.24 |
| Na₂CO₃ | 497-19-8 | 99.0% | 106 | 0.117 |

Nominal MW RE₂(CO₃)₃ = 393, Expected Final Mass = 11.8 g (as carbonate)

### Example 8

### Holmium-Yttria Ceramic

This particular pigment is simply the dehydrated form of example 7. The pigment from example 7 can be calcined at an extremely high temperature, typically 1000° C. to 1500° C., to yield yttria ceramic, which is known for good durability (i.e., solvent and pH resistance) and transparency.

It is noteworthy that Holmium-Yttria Ceramic illustrates the ability to form mixed ceramic compounds that still exhibit a color inconstancy effect. Mixed ceramic compounds such as the one described in the example offer a route to lower cost pigments since Yttrium is significantly less expensive than Holmium. Also note that Examples 7 and 8 are not limited to Holmium-yttria mixtures, but also other lanthanides, including but not limited to praseodymium, dysprosium, neodymium, and ytterbium.

### Example 9

### Neodymium Phosphate Pigment

The neodymium phosphate pigment has a different color transition, compared to holmium phosphate-sulfide pigments. It undergoes a blue-gray to violet transition. The synthesis method is nearly identical to example 1. The typical recipe is given below.

Formulation Recipe for Neodymium Phosphate Pigment

| Chemical Name | CAS# | Purity | MW | Mole |
|---|---|---|---|---|
| Nd(NO₃)₃•6H₂O | 16454-60-7 | 99.9% | 438 | 0.42 |
| NaPO₃* | 68915-31-1 | Prac Gd | 102 | 1.68 |
| Na₂S•9H₂O | 1313-84-4 | 99.9% | 240 | 0.662 |

Nominal MW Nd₂S₃ = 384, Theoretical Final Mass = 80.6 g
[Na₂S] = 0.5M, Phosphate:Nitrate = 4:1, Na₂S:RE = 3.15:2 with 5% excess

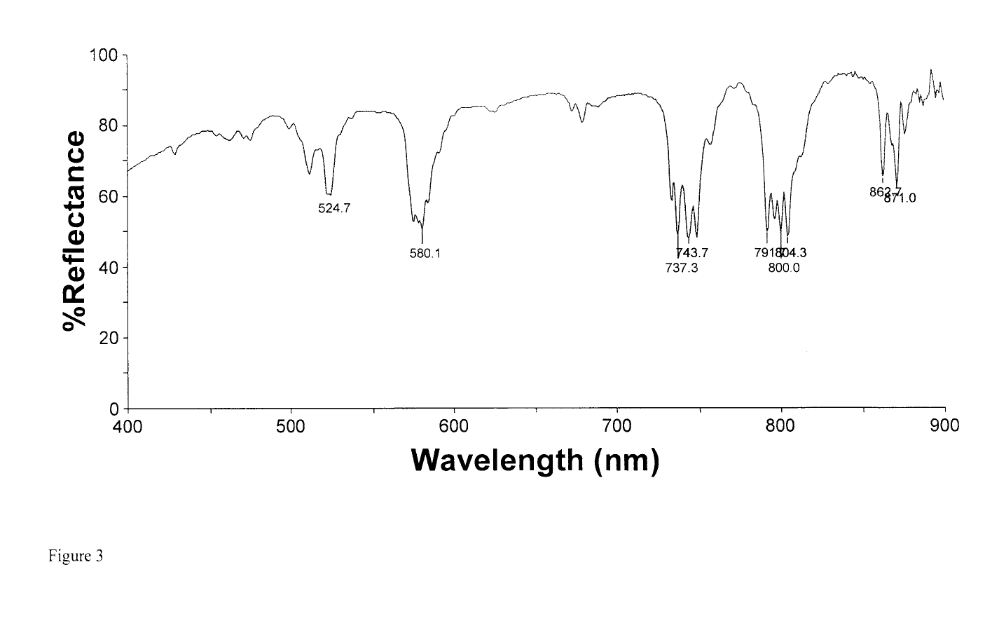

Attenuated Total Reflectance Spectrum of Nd phosphate based pigment is shown in FIG. 3.

### Example 10

### Ho₂O₃ Pigment

Holmium oxide pigments are prepared in chilled ethanol by precipitation of an alcoholic solution of holmium nitrate (6.95 g in a saturated solution) using LiOH (0.84 g in 200 ml EtOH) in a manner similar to the preparation of ZnO pigments as described by Zhou, Alves, et al. (Phys. Stat. Sol. (b) 229 No. 2, pp. 825-828, 2002). Sodium hexametaphosphate (1.14 g) is added as a sequestering agent to assist in formation of small particles. The resulting material exhibits the ultra-color inconstancy effect with a pink-yellow transition, based upon illumination wavelength. Note: The term “sequestering agent” is used to define a chemical entity that can cover part of another material and render it stable and soluble. In the present case, the agent prevents the formation of aggregates to maintain a smaller particle size. Other agents that can act as sequestering agents are chelates such as citrate, EDTA, crown ethers and some amine compounds as well. Surface active agents in general may be considered “sequestering agents”.

### Example 11

### Praseodymium Phosphate/Sulfide Pigment

Praseodymium phosphate pigments are prepared according to the method of example 1. The color transition of the resulting material is a pale green in outdoor light to a weak grey-yellow in triphosphor light.

### Example 12

### Mixed Rare Earth Phosphate Pigments

Rare earths made by methods described in the earlier examples are mixed to produce different color effects. The examples below provide the color transitions observed with different ratios of rare earth metals.

| | Observed color transition (from tri-phosphor to |
|---|---|
| Ratio of Fused pigments | daylight) |
| 2 Ho/1 Pr | pink (triphophor) to light grey (daylight) |
| 1 Ho/2 Pr | pale pink (triphosphor) to light grey (daylight) |
| 2 Nd/1 Ho | pink to violet |

### Example 13

### Dysprosium Phosphate Pigment

Dysprosium Phosphate is made by the method used in example 1 (replacing the Holmium nitrate with Dysprosium nitrate at equal molar quantity). The resulting pigments are useful as a multi-peak near-infrared absorber in the range between 800˜1400 nm.

### Example 14

### Ytterbium Pigment

Ytterbium sulphide/phosphate pigments are made by the method of example 1 (replacing Holmium nitrate with Ytterbium nitrate). The resulting pigment may be useful as a multi-peak near-infrared absorber with absorption peaks at about 954 and 977 nm.

### Example 15

### General Scale-Up Procedures

A slightly modified procedure is used to recover the material when made on a larger scale. When done on a larger scale (e.g., 5 L), filter the crystals after they have precipitated. This takes about 2 days of “aging” for the crystals to precipitate. Note that this aging is an optional step in the process. A vacuum filtration funnel is then used to remove as much of the mother liquor as possible (which may take 6-7 hours). Rinse the resulting crystals with ethanol (2×1 L). The material is then dried in the oven to yield about 80 g of material which is then calcined at high temperature.

### Example 16

### Neodymium Oxide pigments

Neodymium oxide pigments were made using a similar method to the one used to produce the holmium oxide of example 8. Neodymium (III) acetate was dissolved in dry ethanol and precipitated under chilled conditions using tetramethylammonium hydroxide as the base. A small amount of tetraethyl orthosilicate was added to arrest crystal growth by Ostwald ripening. After isolation, the Neodymium oxide pigments produced exhibited visible color inconstancy when exposed to an illumination source changing from a broad spectral distribution (such as illuminant D65) and a discrete spectral distribution such as illuminant TL84.

### Example 17-1 to 17-12

### Neodymium Phosphate Pigment Procedure

The following examples are intended to illustrate the invention without limiting it in any way. These examples demonstrate the impact of key processing conditions (molar ratio of phosphorus to neodymium, mass fraction of neodymium in the final reaction solution, reaction end pH, and reaction temperature) on the product yield and reflectance spectrum.

A solution of Nd(NO₃)₃.6H₂O (100 g) in distilled water (67.3 g) at 50° C. was added at 10 mL/min using a peristaltic pump, to a solution of sodium hexametaphosphate (SHMP) (116.3 g) and distilled water (269.4 g) in a 1 L jacketed pot reactor, with a PTFE blade agitator stirring at 400 rpm. Following complete addition of the Nd(NO₃)₃.6H₂O solution, the mixture was agitated for 30 minutes. The final pH was adjusted to 3.1 by the addition of 10M NaOH. The mixture was then aged for 24 hours at 25° C. After aging, the purple opaque suspension was filtered by vacuum filtration, and the resulting filter cake was washed with water and dried in a vacuum oven at 120° C. for 1 hour. The dry solid product was then placed in a glazed high form porcelain crucible (part #60112, Coorstek, Golden, Colo.) and calcined at 1095° C. (Barnstead Thermolyne 1400 Furnace, Barnstead International, Dubuque, Iowa) for a dwell time of 1 hour. Under these conditions, the calcined pigment fused to the surface of the porcelain crucible. The product pigment was retrieved by adding water to the crucible and sonicating at 40-50° C. Sonication released the fused pigment from the crucible and dispersed it to form an aqueous suspension. The product crystals were filtered by vacuum filtration and the resulting material was washed with water, and dried in a vacuum oven at 120° C. for 1 hour to form example 17-1.

The following examples, 17-2 to 17-12, are conducted in the same manner as Example 17-1 except that the concentrations of both neodymium nitrate and SHMP, the amount of SHMP, the reaction end pH and the reaction temperature are varied. The experimental protocol and results for these examples is summarized in the tables below. The adjustment of the final pH was achieved using 10M NaOH or concentrated phosphoric acid (85 wt %). Sonication was not required for materials that did not fuse to the crucible.

### EXAMPLE 17

### Neodymium Phosphate Reaction Conditions

| | | | H₂O (g), | | | | |
|---|---|---|---|---|---|---|---|
| | H₂O (g), solvent | | solvent | | | | |
| | for 100 g of | SHMP | for | P/Nd | % Nd | Temp | Final |
| Example | Nd(NO₃)₃•6H₂O | (g) | SHMP | (mol/mol) | (g/g) | (° C.) | pH |
| 17-1 | 67.3 | 116.3 | 336.7 | 5 | 0.0595 | 50 | 3.1 |
| 17-2 | 155.0 | 93.04 | 774.8 | 4 | 0.0340 | 80 | 1 |
| 17-3 | 111.6 | 116.3 | 557.9 | 5 | 0.0425 | 70 | 3.1 |
| 17-4 | 39.6 | 186.1 | 197.9 | 8 | 0.0680 | 80 | 1 |
| 17-5 | 58.2 | 93.04 | 290.9 | 4 | 0.0680 | 40 | 1 |
| 17-6 | 155.0 | 93.04 | 774.8 | 4 | 0.0340 | 40 | 9.5 |
| 17-7 | 34.6 | 186.1 | 197.9 | 8 | 0.0680 | 40 | 9.5 |
| 17-8 | 136.3 | 186.1 | 681.7 | 8 | 0.0340 | 80 | 9.5 |
| 17-9 | 81.1 | 139.6 | 405.6 | 6 | 0.0510 | 60 | 5.3 |
| 17-10 | 136.3 | 186.1 | 681.7 | 8 | 0.0340 | 40 | 1 |
| 17-11 | 58.2 | 93.04 | 290.9 | 4 | 0.0680 | 80 | 9.5 |
| 17-12 | 58.2 | 93.04 | 290.9 | 4 | 0.0680 | 80 | 1 |

### Example 17

### Neodymium Phosphate Reaction Results

| | | | Nd | Composition | | |
|---|---|---|---|---|---|---|
| | | Requires | Recovered | Nd | P | Na |
| Example | Yield (g) | Sonication | (g/g) | Wt % | Wt % | Wt % |
| 17-1 | 45.9 | Yes | 0.588 | 42.2 | 25.1 | 0 |
| 17-2 | 37.6 | No | 0.627 | 54.9 | 20.6 | 0 |
| 17-3 | 34.7 | Yes | 0.614 | 58.3 | 7.5 | 0 |
| 17-4 | 13.9 | Yes | 0.238 | 56.4 | 8.3 | 0 |
| 17-5 | 52.9 | No | 0.697 | 43.4 | 24.3 | 0 |
| 17-6 | 44.2 | Yes | 0.809 | 60.3 | 8.2 | 0 |
| 17-7 | 45.1 | Yes | 0.838 | 61.2 | 11.6 | 0 |
| 17-8 | 49.8 | Yes | 0.933 | 61.7 | 9.9 | 0 |
| 17-9 | 40.9 | Yes | 0.730 | 58.8 | 8.4 | 0 |
| 17-10 | 0 | — | 0.000 | N/A | N/A | N/A |
| 17-11 | 53.2 | Yes | 0.976 | 60.4 | 9.1 | 0 |
| 17-12 | 60.1 | No | 0.854 | 46.8 | 15.5 | 0.7 |
| NdPO4 | | | | 60.3 | 12.9 | 0 |

### Example 17

### Neodymium to Phosphate Mole Ratio

| | Rare Earth |
|---|---|
| | element to |
| | phosphate |
| Example | ratio |
| 17-1 | 0.36 |
| 17-2 | 0.57 |
| 17-3 | 1.67 |
| 17-4 | 1.46 |
| 17-5 | 0.38 |
| 17-6 | 1.58 |
| 17-7 | 1.13 |
| 17-8 | 1.34 |
| 17-9 | 1.50 |
| 17-10 | N/A |
| 17-11 | 1.43 |
| 17-12 | 0.65 |
| NdPO4 | 1.00 |

Examples 17-1 to 17-9, 17-11 and 17-12 include a variety of reaction conditions with similar product performance with regards to reflectance. Examples 17-2, 17-3, 17-4, 17-6, and 17-12 have the strongest absorption bands, particularly at 743 and 800 nm.

The impact of reaction temperature on product yield is illustrated by comparing Example 17-12 and Example 17-5. These examples differ only in reaction temperature (Example 17-5: 40° C., Example 17-12: 80° C.). Although both examples have similar product performance, the increase in reaction temperature results in a product yield increase of 13.6 percent. This increase is perhaps due to improved conditions for crystallization. At higher temperature, the solubility of the crystals is increased. Of course, the solubility of smaller precipitates is higher than larger crystals. Thus, as the reaction temperature drops during aging, product precipitation occurs on the surface of insoluble larger crystals resulting in increased particle growth. This allows for more efficient separation during filtration and thus improved product yield.

The comparison of Examples 17-11 and 17-12 indicate that good product yield can be achieved under both low and high pH conditions in the final solutions. However, the use of a lower final reaction pH resulted in a higher overall product yield.

The composition of the product pigment is influenced by the final solution pH. At a pH of 9.5 (Example 17-11), the final product contained 60.4 and 9.1 weight percent Nd and P, respectively; as determined by X-ray fluorescence analysis (Fisions Instruments, Model ARL 9400 Sequential XRF). This composition is similar to the weight percent of 60.3 and 12.9, for Nd and P, respectively, in pure NdPO₄. In fact, both Example 17-11 and neodymium phosphate hydrate (Alfa Aesar, CAS 14298-32-9, dried at 200-250° C.), show similar diffraction patterns, with peaks at about 19.1±0.2, 21.4±0.2, 27.1±0.2, 29.1±0.2, 31.5±0.2, 37.2±0.2, 48.9±0.2, 53.0±0.2 degrees two-theta (Siemens D5005 X-ray Diffractometer). A comparison of the average peak ratios at 2θ=27.2/42.4°, 29.0/42.4°, 29.0/46.6° and 29.0/48.9° for Example 17-11 and commercially available neodymium phosphate hydrate (Alfa Aesar, CAS 14298-32-9, dried at 200-250° C.) is shown in the table below.

| XRD Peak | Alfa Aesar | |
|---|---|---|
| Ratio | (CAS 14298-32-9) | Example 17.11 |
| 2θ = 27.2/42.4° | 1.92 | 1.75 |
| 2θ = 29.0/42.4° | 3.50 | 2.79 |
| 2θ = 29.0/46.6° | 2.98 | 4.44 |
| 2θ = 29.0/48.9° | 3.31 | 4.62 |

The reduced phosphorus content observed in Example 17-11 may be due to the presence of small amounts of neodymium oxide (Nd₂O₃).

Under low pH conditions, such as a pH of 1 (Example 17-12), the final product contained 46.8 and 15.5 weight percent Nd and P, respectively. This lower weight percent of neodymium and higher weight percent of phosphorus may be due to the presences of polyphosphorus compounds, such as, but not limited to, neodymium hexametaphosphate (Nd₂(PO₃)₆) and neodymium trimetaphosphate (Nd(PO₃)₃). FTIR analysis of Example 17-12 shows a small band at 1156 cm⁻¹ suggesting the presence of polyphosphate compounds. This band was not observed for commercially available neodymium phosphate hydrate or neodymium phosphate samples prepared at pH conditions greater than 5.3. Furthermore, differences in the diffraction patterns of Example 17-11 and 17-12 confirms that the two examples have a different composition. The diffraction pattern of Example 17-12 has peaks at 22.7±0.2, 28.9±0.2, 30.8±0.2, 33.4±0.2, 44.2±0.2, 45.2±0.2, 49.6±0.2, 51.4±0.2, 52.1±0.2, 55.7±0.2 degrees two-theta. Despite the reduced weight fraction of Nd in Example 17-12, the absorption intensity in the NIR region is the same, or slightly improved compared to Example 17-11.

Processes with a low pH typically had a reduced interaction between pigment and crucible (see Examples 17-2, 17-5 and 17-12). However, poorer yields were observed for processes using both high P/Nd ratios and acidic conditions (Examples 17-10 and 17-4).

Further improvements in product yield may be achieved by performing the aqueous precipitation method under pressure, which would allow an increase in the reaction temperature.

### Example 18

### Neodymium Phosphate Pigment Procedure

This example illustrates the use of a soft base (Na₂S instead of NaOH) to adjust the final solution pH.

A solution of Nd(NO₃)₃.6H₂O (184 g) in distilled water (516 g) at 25° C. was added at 12 mL/min using a peristaltic pump, to a solution of sodium hexametaphosphate (SHMP) (171 g) and distilled water (1929 g) in a 5 L round bottom reaction, with a PTFE blade agitator stirring at 200 rpm. Following complete addition of the Nd(NO₃)₃.6H₂O solution, the mixture was agitated for 30 minutes. The final pH was adjusted to 8.7 by the addition of Na₂S.9H₂O (159 g) in distilled water (1165 g) at a rate of 12 mL/min. The mixture was then aged for 48 hours at 25° C. After aging, the purple opaque suspension was filtered by vacuum filtration, and the resulting filter cake was washed with water and dried in a vacuum oven at 120° C. for 1 hour. The dry solid product was then placed in a high form porcelain crucible (part #60112, Coorstek, Golden, Colo.) and calcined at 1095° C. (Barnstead Thermolyne 1400 Furnace, Barnstead International, Dubuque, Iowa) for a dwell time of 1 hour. Under these conditions, the calcined pigment fused to the surface of the porcelain crucible. The product pigment was retrieved by adding water to the crucible and sonicating at 40-50° C. Sonication released the fused pigment from the crucible and dispersed it to form an aqueous suspension. The product crystals were filtered by vacuum filtration and the resulting material was washed with water, and dried in a vacuum oven at 120° C. for 1 hour.

The reaction conditions and results associated with example 18 are summarized below. Example 18 resulted in 0.756 g of product per g of neodymium in the starting material. X-ray fluorescence analysis (Fisions Instruments, Model ARL 9400 Sequential XRF) indicates 57.7 weight percent neodymium. This corresponds to 43.6 percent recovery of neodymium from the starting material.

### Example 18

### Neodymium Phosphate Pigment Reaction Conditions

| | P/Nd | % Nd | Temp | End | Yield | Nd | P | Na | S |
|---|---|---|---|---|---|---|---|---|---|
| Example | (mol/mol) | (g/g) | (° C.) | pH | (g/g)* | Wt % | Wt % | Wt % | Wt % |
| 18 | 4.0 | 0.015 | 25 | 8.7 | 0.756 | 57.7 | 8.8 | 0.04 | 0.06 |
| Pure | n/a | n/a | n/a | n/a | n/a | 60.3 | 12.9 | 0 | 0 |
| NdPO₄ | | | | | | | | | |

*Product yield for each example normalized using initial mass of neodymium.

It is also evident that the composition of the final product is influenced by the final solution pH. As described previously, the product of a procedure with a high final solution pH regime closely resembles the composition of pure neodymium phosphate. The slightly lower mass fraction of phosphorus may indicate the presence of small amounts of neodymium oxide (Nd₂O₃).

### Example 19

### Neodymium Phosphate Pigment Procedure

A solution of Nd(NO₃)₃.6H₂O (4 kg) in distilled water (2.3 kg) at 80° C. was added over 33 minutes, to a solution of sodium hexametaphosphate (SHMP) (3.7 kg) and distilled water (9.3 kg) in a 50 L jacketed glass reaction equipped with a turbine type PTFE blade agitator stirring at 400 rpm. Following complete addition of the Nd(NO₃)₃.6H₂O solution, the mixture was agitated for 30 minutes. The final pH of the mixture was 1.4, and the mixture was then aged for 24 hours at 25° C. After aging, the suspension was filtered using a 14″ plate and frame filter press equipped with woven polypropylene filter cloths. The overall mass of wet filter cake recovered was 5.9 kg with solids content of 49.6 percent. This material was then dried at 110° C. for 18 hours resulting in 3.1 kg dry product. The dry solid product was then placed in high alumina crucibles. The temperature of the gas fired kiln was ramped up to 1150° C. over 5 hours, with a dwell time of 1 hour, then was cooled overnight. Calcination reduced the final product mass to 2.45 kg corresponding to 1.86 g product per g of neodymium starting material.

In contrast to Example 17-12, the calcined pigment fused to the surface of the porous crucible material. This may be due to differences in the crucible material used in the different examples; porous instead of the smooth porcelain used in Example 17-12. The product pigment was physically separated from the crucible material using a conventional tile saw equipped with a diamond blade.

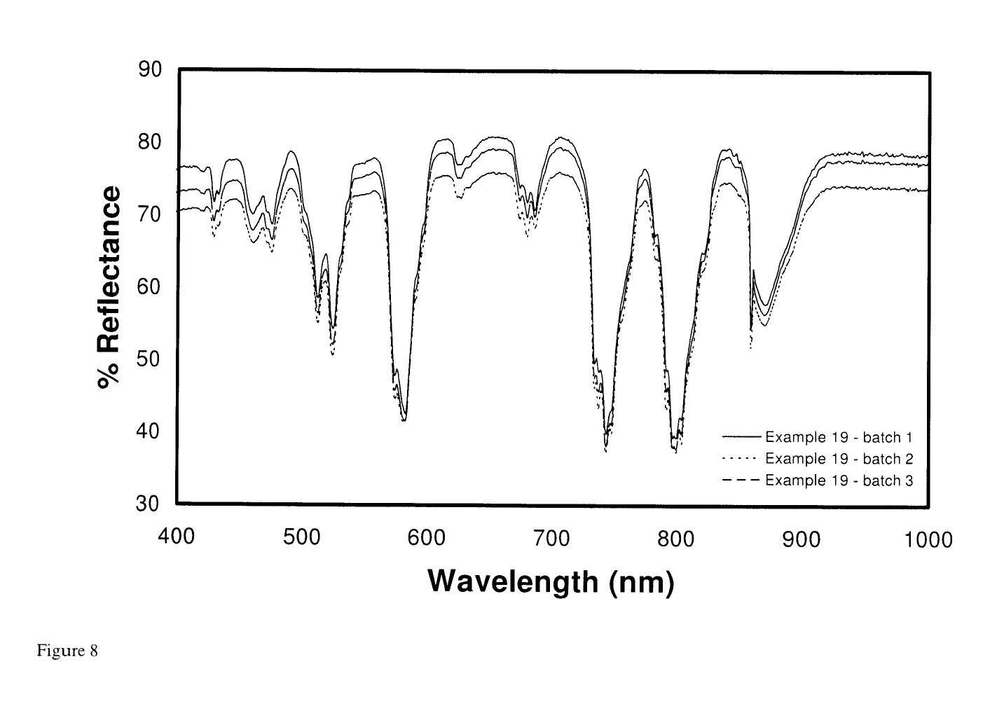

Following calcination, the material was hammer milled to a mean particle size of 41.1 micron and then jet milled to 10.0 micron. Information regarding the particle size distribution for each step is provided in the table below. The reflectance spectrum of three batches of the final product are shown in FIG. 8.

Particle size distribution

| Particle Data | After Hammer Milling | After Jet Milling |
|---|---|---|
| D(10) | 4.6 μm | 1.6 μm |
| D(20) | 9.9 μm | 3.0 μm |
| D(50) | 29.3 μm | 8.8 μm |
| D(80) | 69.0 μm | 15.7 μm |
| D(90) | 94.2 μm | 20.0 μm |
| Mean | 41.1 μm | 10.0 μm |
| SD | 37.6 μm | 7.5 μm |

### Example 19

### Neodymium to Phosphate Mole Ratio

| | | | Nd/ |
|---|---|---|---|
| | | | Phosphate |
| Example | Nd (%) | P (%) | mole ratio |
| 19 - Batch 1, | 48.5% | 15.9% | 0.66 |
| Calcined | | | |
| @1000 C | | | |
| 19 - Batch 4, | 49.1% | 27.0% | 0.39 |
| calcined @1150 C | | | |
| NdPO4 | 60.3% | 12.9% | 1.0 |
| | (assumed) | (assumed) | |

### Example 20

### Security Ink

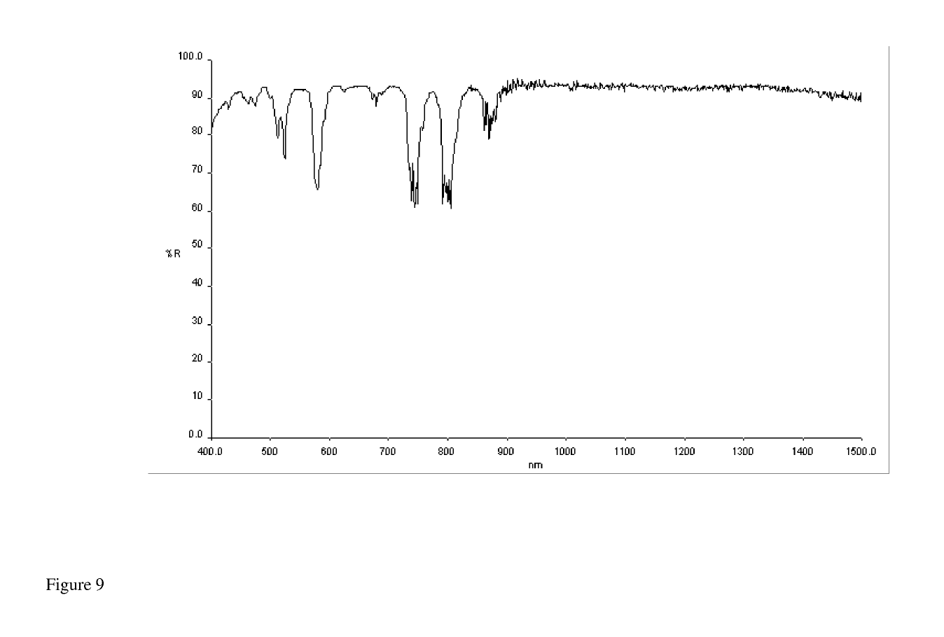

A flexographic ink was prepared by mixing the neodymium phosphate pigment (50% by weight) with a UV flexographic varnish (FEST010, 50% by weight), using a dispermat mixer for 5 minutes at high speed, using a saw tooth was printed onto paper using an RK 185# hand anilox. The print was measured using a Perkin Elmer lambda 900, see FIG. 9.

### Example 21

### Chemical Resistance

The ink of example 20 was proofed using a 180# hand anilox roller onto paper and cured using UV light. A control and a test sample were prepared for 12 different tests shown in the table below. For each test the sample was immersed in the reagent for 30 minutes without agitation. Tests 1-5, 6-9 and 20-21 were pulled out of the reagent and allowed to dry naturally on blotting paper, all other tests were given a good rinse in cold water after being removed from the reagent, before drying in the same way. The two tests at 95° C. were carried out in a condenser, and the other four heated tests were carried out using a hotplate.

Chemical Resistance Tests

| Test | Reagent | Condition |
|---|---|---|
| 1 | Ethyl Alcohol | 96% @ 23° C. |
| 2 | Ethyl Acetate | 100% @ 23° C. |
| 3 | Acetone | 100% @ 23° C. |
| 4 | Tetrachloroethylene | 100% @ 23° C. |
| 5 | Xylene | 100% @ 23° C. |
| 6 | Diethylene Glycol | 100% @ 23° C. |
| 7 | Toluene | 100% @ 23° C. |
| 8 | Petroleum | 100% @ 23° C. |
| 9 | Petrol (B.P. 100-140) | 100% @ 23° C. |
| 10 | Acetic Acid | 20% @ 23° C. |
| 11 | Hydrochloric Acid | 5% @ 23° C. |
| 12 | Sulphuric Acid | 5% @ 23° C. |
| 13 | Hydrogen Peroxide | 5% @ 23° C. |
| 14 | Sodium Hypochlorite | 5% @ 23° C. |
| 15 | Sodium Hydroxide | 5% @ 23° C. |
| 16 | Sodium Sulphide | 5% (ges.) @ 23° C. |
| 17 | Sodium Sulphite | 10% @ 23° C. |
| 18 | Water (60° C.) | 100% @ 60° C. |
| 19 | Water (100° C.) | 100% @ 100° C. |
| 20 | Biological Laundry | 2% OMO @ 95° C. |
| 21 | Industrial Laundry | 0.5% Persil/1% Soda @ 95° C. |
| 22 | Hard Soap Solution | 10% pH 10.3 @ 80° C. |
| 23 | Syn. Perspiration (23° C.) | DIN53160 @ 23° C. |
| 24 | Syn. Perspiration (40° C.) | DIN53160 @ 40° C. |

After the tests were carried out, and the squares allowed to dry overnight, each one was tested on the Lambda 900 versus the equivalent pre-tested spectral curve. Each test showed no change in spectral curve

### Example 22

### Intaglio Security Ink

An intaglio ink was prepared from the ingredients listed in the table below. The procedure for mixing is as follows:

1. Weigh and combine all the ingredients of part A. Mix with a Bema labotech 60 mixer, for 5 minutes, at 400 rpm, using a butterfly mixer blade.

2. Weigh all the ingredients of part B, and add to the mixture of the previous step. Mix with a Bema labotech 60 mixer, for 5 minutes, at 400 rpm, using a butterfly mixer blade.

3. Weigh all the ingredients of part C, and add to the mixture of the previous step. Mix with a Bema labotech 60 mixer, for 5 minutes, at 400 rpm, using a butterfly mixer blade.

4. Mill the mixture with a triple roll mill until FOG is less than 10 μm.

5. Weigh all the ingredients of part D, and add to the mixture of the previous step. Mix with a Bema labotech 60 mixer, for 5 minutes, at 400 rpm, using a butterfly mixer blade.

| Description | Supplier | | Percentage | Part |
|---|---|---|---|---|
| High AV Alkyd | DIC | Alkyd | 13.80 | A |
| E20165 Urethane | Cray Valley | Urethane | 28.40 | |
| Marlon ARL | Sasol | Surfactant | 4.00 | |
| Pigment Yellow 13 | SunChemical | Pigment | 3.37 | B |
| Pigment Violet | SunChemical | Pigment | 1.80 | |
| Pigment Blue 15:3 | Ciba | Pigment | 0.82 | |
| Exxsol D80 | Exxsol | Solvent | 5.00 | C |
| Snauba 5021 | Shamrock | Wax | 4.00 | |
| Polyfluo 540 | Micro Powders | Wax | 4.00 | |
| Manosec Manganese | Univar | Drier | 0.22 | D |
| Manosec Cobalt | Ellis Everard | Drier | 0.22 | |
| DriRx | OMG | Drier | 0.07 | |
| 1106-065 Nd-based NIR | SunChemical | Pigment | 34.30 | |
| Absorber | | | | |
| | | | 100.00 | |

Prufbau and intaglio prints were prepared using the setting shown below:

Prufbau

i. Pressure: 980 Newtons
ii. Ink weight: 0.8 grm
iii. Distribution: 10 seconds on “inking distribution roller,” 15 seconds on “print forme”
iv. Temp: 23° C.
v. Speed: 0.5 M/sec

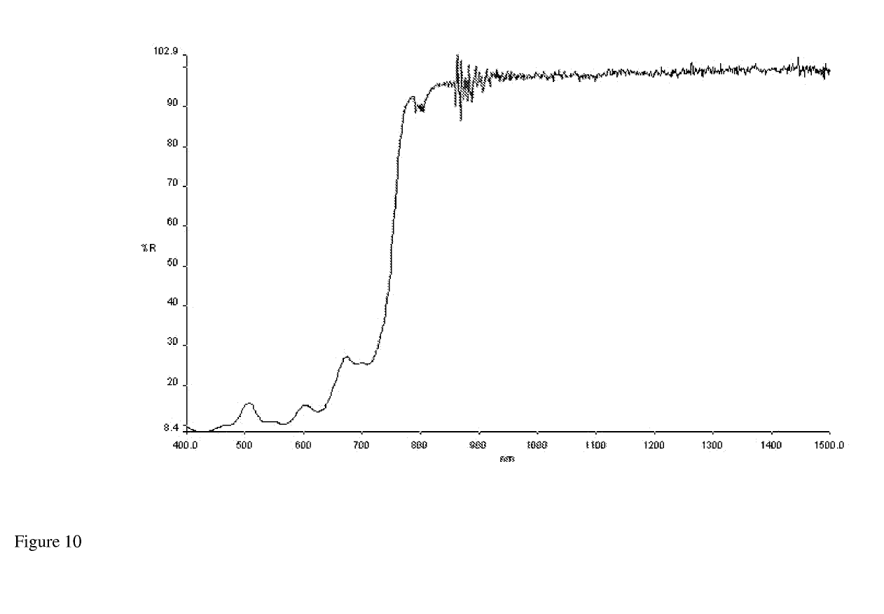

After the print was allowed to dry for 24 hours, the spectra of the print was measured using a Perkin Elmer lambda 900, see FIG. 10.

### Example 23

Additional rare earth phosphate pigments were made according to the procedure of example 17-6 and calcined at 1000° C. Peaks from the IR reflectance spectra are shown in the table below.

Rare earth phosphate pigment reflectance spectra

| Sample | Peaks, NM |
|---|---|
| Cerium Phosphate | 1386 |
| Dysprosium Phosphate | 1715, 1306, 1114, 917, 814, 762, 475, |
| | 453, 429 |
| Erbium Phosphate | 1535, 1506, 982, 797, 653, 545, 523, 489, |
| | 455, 451, 445, 407 |
| Europium Phosphate | 1903 |
| Holmium Phosphate | 1187, 1158, 897, 643, 541, 487, 455, 419 |
| Lanthanum Phosphate | 1386 |
| Neodymium Hydroxide | 1606, 895, 817, 751, 599, 537, 521 |
| Neodymium Phosphate | 873, 797, 745, 582, 524, 512 |
| Praseodymium Phosphate | 1574, 1015, 591, 484, 472, 444 |
| Samarium Phosphate | 1526, 1478, 1417, 1378, 1259, 1234, |
| | 1080, 945, 477, 415 |
| Terbium Phosphate | 1879, 1386 |
| Yttrium Phosphate | 1926, 1388 |

What is claimed is:

1. A crystalline compound comprising neodymium and phosphate characterized by an X-ray powder diffraction pattern comprising peaks at 19.1±0.2, 21.4±0.2, 27.1±0.3, 29.1±0.3, 31.5±0.3, 37.2±0.4, 42.5±0.4, 46.0±0.5, 48.9±0.5, 53.0±0.5, degrees two-theta, and wherein the neodymium to phosphate mole ratio is not 1.

2. The crystalline compound of claim 1, wherein the neodymium to phosphate mole ratio is greater than about 1.

3. A crystalline compound comprising neodymium and phosphate characterized by an X-ray powder diffraction pattern comprising peaks at 30.8±0.3, 33.3±0.3, 44.5±0.5, 51.9±0.6, 55.4±0.6, degrees two-theta.

4. A crystalline compound according to claim 3 further characterized by an X-ray diffraction pattern comprising peaks at 13.6±0.2, 16.6±0.2, 27.7±0.3, 34.4±0.3, 36.9±0.4, 43.1±0.4, 48.3±0.5, degrees two-theta.

5. The crystalline compound of claim 3, wherein the neodymium to phosphate mole ratio is less than about 1.

6. A process for preparing a pigment having a rare earth element, comprising: a) preparing a rare earth element based solution; b) combining the rare earth element based solution with one or more phosphate compounds to form a rare earth phosphate pigment; wherein at least one phosphate compound is a polyphosphate; and c) isolating the pigment from the solution.

7. The process of claim 6, wherein the pigment has an IR band at about 1273 cm⁻¹.

8. The process of claim 6, wherein before the isolation of the pigment, the rare earth phosphate slurry has a pH of about 5.3 or less, or the pH is adjusted to about 5.3 or less by the addition of an acid.

9. The process of claim 6, wherein at the polyphosphate compound is a hexametaphosphate.

10. The process of claim 6, further comprising heat-treating the pigment at or above 700° C.

11. The process of claim 8, wherein the acid is a mineral acid.

12. The process of claim 8, wherein the acid is selected from phosphoric and nitric acid.

13. The process of claim 6, wherein the mass of the rare earth element is greater than about 3 w % of the total mass of the rare earth phosphate reaction solution.

14. The process of claim 6, further comprising re-slurrying the pigment in water bath.

15. The process of claim 6, further comprising re-slurrying the pigment using an ultrasonic process.

16. The process of claim 14, further comprising milling the pigment to a mean particle size of less than or equal to about 20 μm.

17. The process of claim 6, wherein the rare earth element to phosphate mole ratio is not 1.

18. The process of claim 6, wherein the rare earth element comprises an element selected from the group consisting of praseodymium, neodymium, holmium, ytterbium, samarium, erbium, and dysprosium.

19. The process of claim 18, wherein the rare earth element pigment has an X-ray powder diffraction pattern comprising peaks at 30.8±0.3, 33.3±0.3, 44.5±0.5, 51.9±0.6, 55.4±0.6, degrees two-theta.

20. The process of claim 18, wherein the rare earth element pigment is further characterized by an X-ray diffraction pattern comprising peaks at 13.6±0.2, 16.6±0.2, 27.7±0.3, 34.4±0.3, 36.9±0.4, 43.1±0.4, 48.3±0.5, degrees two-theta.

21. The process of claim 18, wherein the rare earth element is neodymium.

22. The process of claim 21, wherein the neodymium to phosphate mole ratio is less than about 1.

23. The process of claim 6, further comprising encapsulating or partially encapsulating the pigment.

24. The process of claim 23, wherein the encapsulating material is a glass.

25. The process of claim 24, wherein the glass is selected from silica and borosilicate.

26. The process of claim 6, wherein the encapsulating material is a polymer.

27. A crystalline compound having a rare earth element, prepared by the process comprising: a) preparing a rare earth element based solution; b) combining the rare earth element based solution with one or more phosphate compounds to form a rare earth element phosphate pigment; and c) isolating the pigment from the solution; wherein the rare earth element to phosphate mole ratio is not 1.

28. The process of claim 27, further comprising heat treating the pigment at or above 700° C.

29. The process of claim 27, wherein before the isolation of the pigment, the rare earth element phosphate slurry has a pH of about 5.3 or less, or the pH is adjusted to about 5.3 or less by the addition of an acid.

30. The process of claim 29, wherein the acid is a mineral acid.

31. The process of claim 30, wherein the acid is selected from phosphoric and nitric acid.

32. The process of claim 27, wherein the mass of the rare earth element is greater than about 3 w % of the total mass of the rare earth phosphate reaction solution.

33. The process of claim 27, further comprising re-slurrying the pigment in a water bath.

34. The process of claim 27, wherein the pigment is re-slurried using an ultrasonic process.

35. The crystalline compound of claim 27, wherein the rare earth element to phosphate mole ratio is greater than about 0.35.

36. The crystalline compound of claim 27, wherein the rare earth element is neodymium.

37. The crystalline compound of claim 36, wherein the neodymium to phosphate mole ratio is less than about 1.

38. The crystalline compound of claim 36, wherein the pigment has an X-ray powder diffraction pattern comprising peaks at 30.8±0.3, 33.3±0.3, 44.5±0.5, 51.9±0.6, 55.4±0.6 degrees two-theta.

39. A printing ink comprising a pigment comprising a rare earth element and a phosphate, wherein the printing ink further comprises a binding agent, so as to produce an ink with a suitable rheology to be printed by at least one of the printing techniques selected from screen, intaglio, gravure, flexo, offset, inkjet, thermal transfer, xerography and letterpress.

40. A printing ink of claim 39, wherein the pigment is prepared by the process comprising: a) preparing a rare earth element based solution; b) combining the rare earth element based solution with one or more phosphate compounds to form a rare earth element phosphate pigment; and c) isolating the pigment from the solution.

41. The printing ink of claim 40, wherein the rare earth element is neodymium.

42. The printing ink of claim 39, wherein the rare earth element to phosphate mole ratio is less than 1.

43. The printing ink of claim 39, wherein the ink is used to form a security taggant that is detectable by a device comprising one or more of visible, near infrared, or infrared light sources to interrogate the security taggant and one or more detectors capable of sensing the portion of the light emitted by the light source that is reflected from the security taggant.

44. The printing ink of claim 43, wherein the light source(s) comprises one or more electroluminescent source.

45. The printing ink of claim 43, wherein the light source(s) comprises one or more lasers or laser diodes.

46. The printing ink of claim 43, wherein the detection of the security taggant is performed in a device equipped to identify banknotes.

47. The printing ink of claim 43, wherein the detection of the security taggant is performed in a device equipped to sort banknotes by denomination.

48. The printing ink of claim 43, wherein each detector is selected from the group consisting of a photodiode, a photovoltaic cell, a metal-semiconductor-metal photodetector, a photomultiplier, a phototransistor, a photoresistor, a light to frequency converter, and a phototube; wherein the detector is optionally fitted with an optical filter.

49. The printing ink of claim 43, wherein the security taggant formed by the ink is used to authenticate an article by the spectral characteristics of the security taggant on the document.

50. A coating or adhesive formulation comprising a pigment comprising a rare earth element and a phosphate, wherein the formulation further comprises a binding agent, so as to produce or coating or adhesive formulation with a suitable rheology to be applied by at least one of the coating techniques selected from the group consisting of flood coating, spray coating, powder coating, hot melt, lamination, roll coating, and reverse roll coating.

51. The coating or adhesive of claim 50, wherein the pigment is prepared by the process comprising: a) preparing a rare earth element based solution; b) combining the rare earth element based solution with one or more phosphate compounds to form a rare earth element phosphate pigment; and c) isolating the pigment from the solution.

52. The coating or adhesive of claim 51, wherein the rare earth element is neodymium.

53. The coating or adhesive of claim 50, wherein the rare earth element to phosphate mole ratio is less than about 1.

54. The coating or adhesive of claim 50, wherein the coating or adhesive is used to form a security taggant that is detectable by a device comprising one or more of visible, near infrared, or infrared light sources to interrogate the security taggant and one or more detectors capable of sensing the portion of the light emitted by the light source that is reflected from the security taggant.

55. The coating or adhesive of claim 54, wherein the light source(s) comprises one or more electroluminescent source.

56. The coating or adhesive of claim 54, wherein the light source(s) comprises one or more lasers or laser diodes.

57. The coating or adhesive of claim 54, wherein the detection of the security taggant is performed in a device equipped to identify banknotes.

58. The coating or adhesive of claim 54, wherein the detection of the security taggant is performed in a device equipped to sort banknotes by denomination.

59. The coating or adhesive of claim 54, wherein each detector is selected from the group consisting of a photodiode, a photovoltaic cell, a metal-semiconductor-metal photodetector, a photomultiplier, a phototransistor, a photoresistor, a light to frequency converter, and a phototube; wherein the detector is optionally fitted with an optical filter.

60. The coating or adhesive of claim 54, wherein the security taggant formed by the coating or adhesive is used to authenticate an article by the spectral characteristics of the security taggant on the document.

61. The composition comprising a polymer and a pigment, wherein the pigment comprises a rare earth element and a phosphate, wherein the rare earth element to phosphate mole ratio is not 1.

62. A composition of claim 61, wherein the pigment is prepared by the process comprising: a) preparing a rare earth element based solution; b) combining the rare earth element based solution with one or more phosphate compounds to form a rare earth element phosphate slurry; and c) isolating the pigment from the slurry.

63. The composition of claim 61, wherein the rare earth element is neodymium.

64. An article comprising a pigment, wherein the pigment comprises a rare earth element and a phosphate.

65. The article of claim 64, wherein the rare earth element to phosphate mole ratio, of the pigment, is not 1.

66. The article of claim 64, wherein the rare earth element is neodymium.

67. The article of claim 64, wherein the ink or coating comprises the pigment, and the ink or coating is printed or applied onto the article.

68. The article of claim 64, wherein the pigment in incorporated into the article.

69. The article of claim 64, wherein the article is selected from the group consisting of: an identification card, identification paper, official or government documents or memos, currency, credit card, driver's license, access card, security card, certificate, and tax stamp.
